(19) United States
(12) Patent Application Publication
(10) Pub. No.: US 2011/0141149 A1
(43) Pub. Date: Jun. 16, 2011

(54) DISPLAY DEVICE, METHOD FOR CORRECTING UNEVEN LIGHT EMISSION AND COMPUTER PROGRAM

(75) Inventors: Yasuo Inoue, Tokyo (JP); Ken Kikuchi, Tokyo (JP); Hideto Mori, Tokyo (JP)

(73) Assignee: SONY CORPORATION, Tokyo (JP)

(21) Appl. No.: 12/667,705

(22) PCT Filed: Jul. 11, 2008
(86) PCT No.: PCT/JP2008/062550

§ 371 Date: Feb. 14, 2011

(30) Foreign Application Priority Data
Jul. 11, 2007 (JP) 2007-182351

(51) Int. Cl. G09G 5/10

(52) U.S. Cl. 345/690

(57) ABSTRACT

A display device is provided that includes: an unevenness correction information storage unit that stores unevenness correction information used to correct uneven light emission of the display unit; and an unevenness correction unit that corrects uneven light emission of the display unit by reading out the unevenness correction information from the unevenness correction information storage unit and by performing signal processing on the video signal having a linear characteristic. The unevenness correction unit corrects the uneven light emission of the display unit by combining a first correction that is applied in a horizontal direction or a vertical direction of the display unit, and a second correction that is applied to a section of the display unit in which uneven light emission is occurring.

### TECHNICAL FIELD

The present invention relates to a display device, a method for correcting uneven light emission, and a computer program, and more particularly, to an active matrix type display device that is configured such that scanning lines for selecting pixels in a predetermined scan cycle, data lines that provide luminance information for driving the pixels, and pixel circuits for controlling an amount of electric current based on the luminance information and causing light emitting elements to emit light according to the amount of electric current are arranged in a matrix configuration, as well as a drive method for the display device.

### BACKGROUND ART

Liquid crystal display devices that use liquid crystals and plasma display devices that use plasma have found practical application as flat and thin display devices.

A liquid crystal display device provides a backlight, and displays images by altering an array of liquid crystal molecules by application of voltage, passing or blocking light from the backlight. Additionally, a plasma display device causes a plasma state to occur by application of voltage to a gas that is enclosed within a panel, and ultraviolet light produced by energy occurring on return from the plasma state to the original state becomes visible light through irradiation of a fluorescent body, displaying an image.

Meanwhile, in recent years, development has been progressing for self-illuminating type displays employing organic electroluminescent (EL) elements in which the element itself emits light when voltage is applied. When the organic EL element receives energy by electrolysis, it changes from a base state to an excited state, and at the time of return from the excited state to the base state, the difference in energy is emitted as light. The organic EL display device is a display device that displays images using these organic EL elements.

A self-illuminating type display device, unlike a liquid crystal display device, which requires a backlight, requires no backlight because the elements themselves emit light, and thus it is possible to make the structure thin compared to a liquid crystal display device. Additionally, because motion characteristics, viewing angle characteristics, color reproduction performance, and the like are superior to a liquid crystal display device, self-illuminating type display devices using organic EL elements are attracting attention as next-generation flat and thin display devices.

### DISCLOSURE OF THE INVENTION

### Problem to be Solved by the Invention

A manufacturing process of such a self-illuminating type display device includes a process in which thin film transistors (TFTs) that form pixels are exposed to a laser beam. In this exposure process, a single laser beam is spread out in a fan shape by optical means, and the fan-shaped laser beam is used to perform the exposure process of TFTs that are arranged in the vertical direction of a panel that displays images. Then, by moving the panel in the horizontal direction, the exposure process is performed on the TFTs that are arranged on the entire panel.

However, because the laser beam is spread out in a fan shape, in some cases, the laser beam is not irradiated evenly to the panel. As a result, stripe-like uneven light emission is likely to occur in the horizontal direction and the vertical direction of the manufactured panel. Further, in some cases, uneven light emission occurs locally, as well as in the horizontal direction and the vertical direction.

Accordingly, the present invention addresses the problems described above, and it is an object of the present invention to provide a display device, a method for correcting uneven light emission and a computer program that are new and improved and that are capable of effectively correcting uneven light emission that occurs as stripes in the horizontal direction and the vertical direction, and uneven light emission that occurs locally, and capable of displaying images while suppressing uneven light emission.

### Means for Solving the Problem

In order to solve the problems that are described above, according to an aspect of the present invention, there is provided a display device that includes a display unit in which a pixel, a scanning line and a data line are arranged in the form of a matrix, the pixel having a light emitting element that emits light in accordance with an amount of an electric current and a pixel circuit that controls, in accordance with a video signal, an electric current applied to the light emitting element, the scanning line supplying to the pixel, in a predetermined scan cycle, a selection signal that selects the pixel that will emit light, and the data line supplying the video signal to the pixel. The display device is characterized by including: an unevenness correction information storage unit that stores unevenness correction information used to correct uneven light emission of the display unit; and an unevenness correction unit that corrects uneven light emission of the display unit by reading out the unevenness correction information from the unevenness correction information storage unit and by performing signal processing on the video signal having a linear characteristic. The unevenness correction unit corrects the uneven light emission by using a first correction that is applied to a section in which uneven light emission is occurring in a horizontal direction or a vertical direction of the display unit, and/or a second correction that is applied to a section of the display unit in which uneven light emission is occurring.

With the structure described above, the unevenness correction information storage unit stores unevenness correction information used to correct uneven light emission of the display unit, and the unevenness correction unit corrects uneven light emission of the display unit by reading out the unevenness correction information from the unevenness correction information storage unit and by performing signal processing on the video signal having a linear characteristic. The unevenness correction unit corrects the uneven light emission by using the first correction that is applied to a section in which uneven light emission is occurring in the horizontal direction or the vertical direction of the display unit, and/or the second correction that is applied to a section of the display unit in which uneven light emission is occurring. As a result, it is possible to effectively correct uneven light emission that occurs as stripes in the horizontal direction and the vertical direction and uneven light emission that occurs locally.

Further, in order to solve the problems that are described above, according to another aspect of the present invention, there is provided a method for correcting uneven light emission of a display device that includes a display unit in which a pixel, a scanning line and a data line are arranged in the form of a matrix, the pixel having a light emitting element that emits light in accordance with an amount of an electric current and a pixel circuit that controls, in accordance with a video signal, an electric current applied to the light emitting element, the scanning line supplying to the pixel, in a predetermined scan cycle, a selection signal that selects the pixel that will emit light, and the data line supplying the video signal to the pixel. The method for correcting uneven light emission is characterized by including the steps of: storing unevenness correction information used to correct uneven light emission of the display unit; and correcting unevenness by reading out the unevenness correction information stored in the unevenness correction information storing step and by performing signal processing on the video signal having a linear characteristic. The unevenness correction step corrects the uneven light emission by using a first correction that is applied to a section in which uneven light emission is occurring in a horizontal direction or a vertical direction of the display unit, and/or a second correction that is applied to a section of the display unit in which uneven light emission is occurring.

Further, in order to solve the problems that are described above, according to another aspect of the present invention, there is provided a computer program that causes a computer to execute control of a display device that includes a display unit in which a pixel, a scanning line and a data line are arranged in the form of a matrix, the pixel having a light emitting element that emits light in accordance with an amount of an electric current and a pixel circuit that controls, in accordance with a video signal, an electric current applied to the light emitting element, the scanning line supplying to the pixel, in a predetermined scan cycle, a selection signal that selects the pixel that will emit light, and the data line supplying the video signal to the pixel. The computer program is characterized by including the step of correcting unevenness by performing signal processing on the video signal having a linear characteristic, based on unevenness correction information that is used to correct uneven light emission of the display device and that is stored in advance. The unevenness correction step corrects the uneven light emission by using a first correction that is applied to a section in which uneven light emission is occurring in a horizontal direction or a vertical direction of the display unit, and/or a second correction that is applied to a section of the display unit in which uneven light emission is occurring.

### EFFECTS OF THE INVENTION

As described above, according to the present invention, a display device, a method for correcting uneven light emission and a computer program can be provided that are new and improved and that are capable of effectively correcting uneven light emission that occurs as stripes in the horizontal direction and the vertical direction, and uneven light emission that occurs locally, and capable of displaying images while suppressing uneven light emission.

### BRIEF DESCRIPTION OF THE DRAWINGS

FIG. 1 is an explanatory diagram that explains the structure of a display device 100 according to an embodiment of the present invention.

FIG. 2A is an explanatory diagram that explains, in the form of a graph, a transition in a characteristic of a signal that flows in the display device 100 according to the embodiment of the present invention.

FIG. 2B is an explanatory diagram that explains, in the form of a graph, a transition in a characteristic of the signal that flows in the display device 100 according to the embodiment of the present invention.

FIG. 2C is an explanatory diagram that explains, in the form of a graph, a transition in a characteristic of the signal that flows in the display device 100 according to the embodiment of the present invention.

FIG. 2D is an explanatory diagram that explains, in the form of a graph, a transition in a characteristic of the signal that flows in the display device 100 according to the embodiment of the present invention.

FIG. 2E is an explanatory diagram that explains, in the form of a graph, a transition in a characteristic of the signal that flows in the display device 100 according to the embodiment of the present invention.

FIG. 2F is an explanatory diagram that explains, in the form of a graph, a transition in a characteristic of the signal that flows in the display device 100 according to the embodiment of the present invention.

FIG. 3 is a sectional view that shows an example of cross-sectional structure of a pixel circuit that is provided in a panel 158.

FIG. 4 is an equivalent circuit diagram of a 5Tr/1C drive circuit.

FIG. 5 is a timing chart of drive of the 5Tr/1C drive circuit.

FIG. 6A is an explanatory figure that shows an on/off state and the like of each transistor in the 5Tr/1C drive circuit.

FIG. 6B is an explanatory figure that shows the on/off state and the like of each of the transistors in the 5Tr/1C drive circuit.

FIG. 6C is an explanatory figure that shows the on/off state and the like of each of the transistors in the 5Tr/1C drive circuit.

FIG. 6D is an explanatory figure that shows the on/off state and the like of each of the transistors in the 5Tr/1C drive circuit.

FIG. 6E is an explanatory figure that shows the on/off state and the like of each of the transistors in the 5Tr/1C drive circuit.

FIG. 6F is an explanatory figure that shows the on/off state and the like of each of the transistors in the 5Tr/1C drive circuit.

FIG. 6G is an explanatory figure that shows the on/off state and the like of each of the transistors in the 5Tr/1C drive circuit.

FIG. 6H is an explanatory figure that shows the on/off state and the like of each of the transistors in the 5Tr/1C drive circuit.

FIG. 6I is an explanatory figure that shows the on/off state and the like of each of the transistors in the 5Tr/1C drive circuit.

FIG. 7 is an equivalent circuit diagram of a 2Tr/1C drive circuit.

FIG. 8 is a timing chart of drive of the 2Tr/1C drive circuit.

FIG. 9A is an explanatory figure that shows an on/off state and the like of each transistor in the 2Tr/1C drive circuit.

FIG. 9B is an explanatory figure that shows the on/off state and the like of each of the transistors in the 2Tr/1C drive circuit.

FIG. 9C is an explanatory figure that shows the on/off state and the like of each of the transistors in the 2Tr/1C drive circuit.

FIG. 9D is an explanatory figure that shows the on/off state and the like of each of the transistors in the 2Tr/1C drive circuit.

FIG. 9E is an explanatory figure that shows the on/off state and the like of each of the transistors in the 2Tr/1C drive circuit.

FIG. 9F is an explanatory figure that shows the on/off state and the like of each of the transistors in the 2Tr/1C drive circuit.

FIG. 10 is an equivalent circuit diagram of a 4Tr/1C drive circuit.

FIG. 11 is an equivalent circuit diagram of a 3Tr/1C drive circuit.

FIG. 12 is an explanatory figure that explains the configuration of an unevenness correction unit 130 according to the embodiment of the present invention.

FIG. 13 is an explanatory figure that explains a concept of a method for correcting uneven light emission in the display device 100.

FIG. 14A is an explanatory figure that shows known grid type correction that takes the entire screen as a processing region.

FIG. 14B is an explanatory figure that shows that the processing region is limited to just a particular region in which uneven light emission is occurring, and spot correction is performed.

FIG. 15 is an explanatory figure that explains, in the form of a graph, about correction of uneven light emission by the method for correcting uneven light emission in the display device 100 according to the embodiment of the present invention.

FIG. 16 is an explanatory figure that explains a case in which uneven light emission that is locally occurring on the panel 158 is corrected by the spot correction.

FIG. 17 is an explanatory figure that explains the configuration of an unevenness correction unit 130′.

FIG. 18A is an explanatory figure that shows the manner in which unevenness correction is performed in a case where the unevenness correction is also performed on a low gradation side.

FIG. 18B is an explanatory figure that shows the manner in which unevenness correction is performed in a case where the unevenness correction is not performed on a low gradation side.

### DESCRIPTION OF REFERENCE NUMERALS

100 display device
104 control unit
106 recording unit
110 signal processing integrated circuit
112 edge blurring unit
114 I/F unit
116 linear conversion unit
118 pattern generation unit
120 color temperature adjustment unit
122 still image detection unit
124 long-term color temperature correction unit
126 light emission time control unit
128 signal level correction unit
130 unevenness correction unit
132 gamma conversion unit
134 dither processing unit
136 signal output unit
138 long-term color temperature correction detection unit
140 gate pulse output unit
142 gamma circuit control unit
150 storage unit
152 data driver
154 gamma circuit
156 overcurrent detection unit
158 panel
162 level detection unit
164 unevenness correction information storage unit
166, 168 interpolation unit
170 adder

### BEST MODE FOR CARRYING OUT THE INVENTION

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

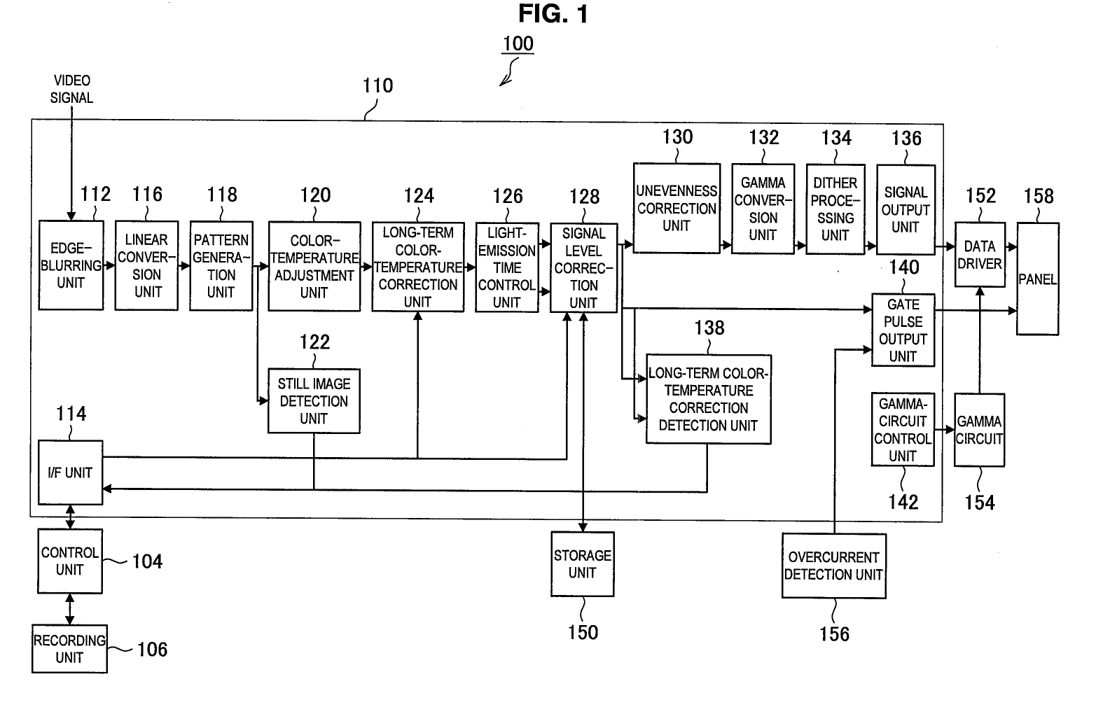

First, a structure of a display device according to an embodiment of the present invention is described. FIG. 1 is an explanatory diagram that explains the structure of a display device 100 according to the embodiment of the present invention. The structure of the display device 100 according to the embodiment of the present invention is described below with reference to FIG. 1.

As shown in FIG. 1, the display device 100 according to the embodiment of the present invention includes a control unit 104, a recording unit 106, a signal processing integrated circuit 110, a storage unit 150, a data driver 152, a gamma circuit 154, an overcurrent detection unit 156, and a panel 158.

The signal processing integrated circuit 110 includes an edge blurring unit 112, an I/F unit 114, a linear conversion unit 116, a pattern generation unit 118, a color temperature adjustment unit 120, a still image detection unit 122, a long-term color temperature correction unit 124, a light emission time control unit 126, a signal level correction unit 128, an unevenness correction unit 130, a gamma conversion unit 132, a dither processing unit 134, a signal output unit 136, a long-term color temperature correction detection unit 138, a gate pulse output unit 140, and a gamma circuit control unit 142.

When receiving a video signal, the display device 100 analyzes the video signal, and turns on pixels arranged in the panel 158, mentioned later, according to the analyzed contents, so as to display a video through the panel 158.

The control unit 104 controls the signal processing integrated circuit 110 and sends and receives signals to and from the I/F unit 114. Additionally, the control unit 104 executes various signal processing on the signals received from the I/F unit 114. The signal processing executed in the control unit 104 includes, for example, calculation of gain to be used for adjusting luminance of an image displayed on the panel 158.

The recording unit 106 is for storing information for controlling the signal processing integrated circuit 110 in the control unit 104 therein. A memory that can store information without deletion of the information even if power of the display device 100 is turned off is preferably used as the recording unit 106. An EEPROM (Electronically Erasable and Programmable Read Only Memory) that can rewrite contents electronically is desirably used as the memory that is adopted as the recording unit 106. The EEPROM is a nonvolatile memory which can write or delete data with the EEPROM being packaged on a substrate, and is suitable for storing information of the display device 100 that changes moment by moment.

The signal processing integrated circuit 110 inputs a video signal and executes signal processing with respect to the input video signal. In the present embodiment, the video signal input into the signal processing integrated circuit 110 is a digital signal, and signal width is 10 bits. The signal processing to be executed on the input video signal is executed in the respective sections in the signal processing integrated circuit 110.

The edge blurring unit 112 executes signal processing for blurring an edge on the input video signal. Specifically, the edge blurring unit 112 intentionally shifts an image and blurs its edge so as to prevent a phenomenon of burn-in of the image onto the panel 158.

The linear conversion unit 116 executes signal processing for converting a video signal whose output with respect to an input has a gamma characteristic into a video signal having a linear characteristic. When the linear conversion unit 116 executes the signal processing so that the output with respect to the input has the linear characteristic, various processing with respect to images displayed on the panel 158 becomes easy. The signal processing in the linear conversion unit 116 widens the signal width of the video signal from 10 bits to 14 bits. Once the video signal has been converted by the linear conversion unit 116 such that it has the linear characteristic, it is converted in the gamma conversion unit 132, which is described later, such that it has the gamma characteristic.

The pattern generation unit 118 generates test patterns to be used in the image processing inside the display device 100. The test patterns to be used in the image processing in the display device 100 include, for example, a test pattern which is used for display inspection of the panel 158.

The color temperature adjustment unit 120 adjusts color temperature of images, and adjusts colors to be displayed on the panel 158 of the display device 100. Although not shown in FIG. 1, the display device 100 includes color temperature adjusting section which adjusts color temperature, and when a user operates the color temperature adjusting section, color temperature of images to be displayed on the screen can be adjusted manually.

The long-term color temperature correction unit 124 corrects deterioration with age due to variation in luminance/time characteristic (LT characteristic) of respective colors R (red), G (green), and B (blue) of organic EL elements. Because the organic EL elements have different LT characteristics of R, G, and B, color balance deteriorates over light emission time. The long-term color temperature correction unit 124 corrects the color balance.

The light emission time control unit 126 calculates a duty ratio of a pulse at the time of displaying an image on the panel 158, and controls the light emission time of the organic EL elements. The display device 100 applies an electric current to the organic EL elements in the panel 158 while the pulse is in a HI state, so as to cause the organic EL elements to emit light and display an image.

The signal level correction unit 128 corrects the level of the video signal and adjusts the luminance of the video to be displayed on the panel 158 in order to prevent an image burn-in phenomenon. In the image burn-in phenomenon, deterioration of light emission characteristics occurs in a case where the light emission frequency of a specific pixel is high compared to other pixels, leading to a decline in luminance of the pixel that has deteriorated compared with other pixels which have not deteriorated, and the difference in luminance with the surrounding portion which has not deteriorated becomes larger. Due to this difference in luminance, text appears to be burned into the screen.

The signal level correction unit 128 calculates the amount of light emission of respective pixels or a pixel group based on the video signal and the duty ratio of the pulse calculated by the light emission time control unit 126, and calculates gain for reducing the luminance according to need based on the calculated amount of luminance, so as to multiply the video signal by the calculated gain.

The long-term color temperature correction detection unit 138 detects information for correction in the long-term color temperature correction unit 124. The information detected by the long-term color temperature correction detection unit 138 is sent to the control unit 104 via the I/F unit 114, and is recorded in the recording unit 106 via the control unit 104.

The unevenness correction unit 130 corrects unevenness of images and videos displayed on the panel 158. In the unevenness correction unit 130, horizontal stripes and vertical stripes of the panel 158 and uneven light emission that occurs in localized areas of the screen are corrected based on the level of an input signal and a coordinate position.

The gamma conversion unit 132 executes signal processing for converting the video signal converted into a signal having a linear characteristic by the linear conversion unit 116 into a signal having a gamma characteristic. The signal processing executed in the gamma conversion unit 132 is signal processing for canceling the gamma characteristic of the panel 158 and converting a signal into a signal having a linear characteristic so that the organic EL elements in the panel 158 emit light according to the electric current of the signal. When the gamma conversion unit 132 performs the signal processing, the signal width changes from 14 bits to 12 bits.

The dither processing unit 134 executes dithering with respect to the signal converted by the gamma conversion unit 132. The dithering provides display where displayable colors are combined in order to express medium colors in an environment in which the number of usable colors is small. By executing dithering by the dither processing unit 134, colors which intrinsically cannot be displayed on the panel can be simulated and expressed. The signal width is changed from 12 bits to 10 bits by the dithering in the dither processing unit 134.

The signal output unit 136 outputs the signal after dithering by the dither processing unit 134 to the data driver 152. The signal sent from the signal output unit 136 to the data driver 152 is a signal multiplied by information about the amount of light emission of respective colors R, G, and B, and the signal multiplied by the information about the light emission time is output in the form of a pulse from the gate pulse output unit 140.

The gate pulse output unit 140 outputs a pulse for controlling the light emission time of the panel 158. The pulse output from the gate pulse output unit 140 is a pulse calculated by the light emission time control unit 126 based on the duty ratio. The pulse from the gate pulse output unit 140 determines the light emission time of each pixel on the panel 158.

The gamma circuit control unit 142 gives a setting value to the gamma circuit 154. The setting value that is given by the gamma circuit control unit 142 is a reference voltage to be given to ladder resistance of a D/A converter contained inside the data driver 152.

The storage unit 150 stores, in association with one another, information on one of a pixel and a group of pixels that emits light that exceeds a specified luminance and information on an amount by which the specified luminance is exceeded. The two types of information become necessary when a luminance is corrected in the signal level correction unit 128. Unlike the recording unit 106, a memory in which contents are deleted when the power is turned off may be used as the storage unit 150, and, for example, SDRAM (Synchronous Dynamic Random Access Memory) is desirably used as such a memory.

In a case where an overcurrent is produced by substrate short circuit or the like, the overcurrent detection unit 156 detects the overcurrent and notifies the gate pulse output unit 140. In a case where an overcurrent is produced, the overcurrent detection and notification by the overcurrent detection unit 156 can prevent the overcurrent from being applied to the panel 158.

The data driver 152 executes signal processing with respect to the signal received from the signal output unit 136, and outputs a signal for displaying video on the panel 158 to the panel 158. The data driver 152 includes a D/A converter that is not shown in the drawings, and the D/A converter converts a digital signal into an analog signal and outputs the analog signal.

The gamma circuit 154 gives a reference voltage to the ladder resistance of the D/A converter contained inside the data driver 152. The reference voltage to be given to the ladder resistance is generated by the gamma circuit control unit 142.

The panel 158 accepts as inputs an output signal from the data driver 152 and an output pulse from the gate pulse output unit 140, causing the organic EL elements, which are examples of self-illuminating type elements, to emit light to display moving images and still images according to the signal and the pulse that are input. In the panel 158, the shape of the surface that displays the images is a plane. The organic EL elements are self-illuminating type elements which emit light when a voltage is applied, and their amount of light emission is proportional to the voltage. Consequently, an IL characteristic (current/light emission amount characteristic) of the organic EL elements also comes to have a proportional relationship.

In the panel 158, not shown in the figure, scanning lines that select pixels in a predetermined scanning cycle, data lines that give luminance information for driving the pixels, and pixel circuits that control the amount of electric current based on the luminance information and cause the organic EL elements as light emitting elements to emit light according to the amount of electric current, are structured by arrangement in a matrix pattern. As the scanning lines, the data lines and the pixel circuits are configured in this way, the display device 100 can display video images in accordance with the video signals.

The structure of the display device 100 according to the embodiment of the present invention has been described above with reference to FIG. 1. The display device 100 according to the embodiment of the present invention depicted in FIG. 1 converts a video signal to a signal having a linear characteristic using the linear conversion unit 116 and thereafter inputs the converted video signal into the pattern generation unit 118, but the pattern generation unit 118 and the linear conversion unit 116 may be interchanged.

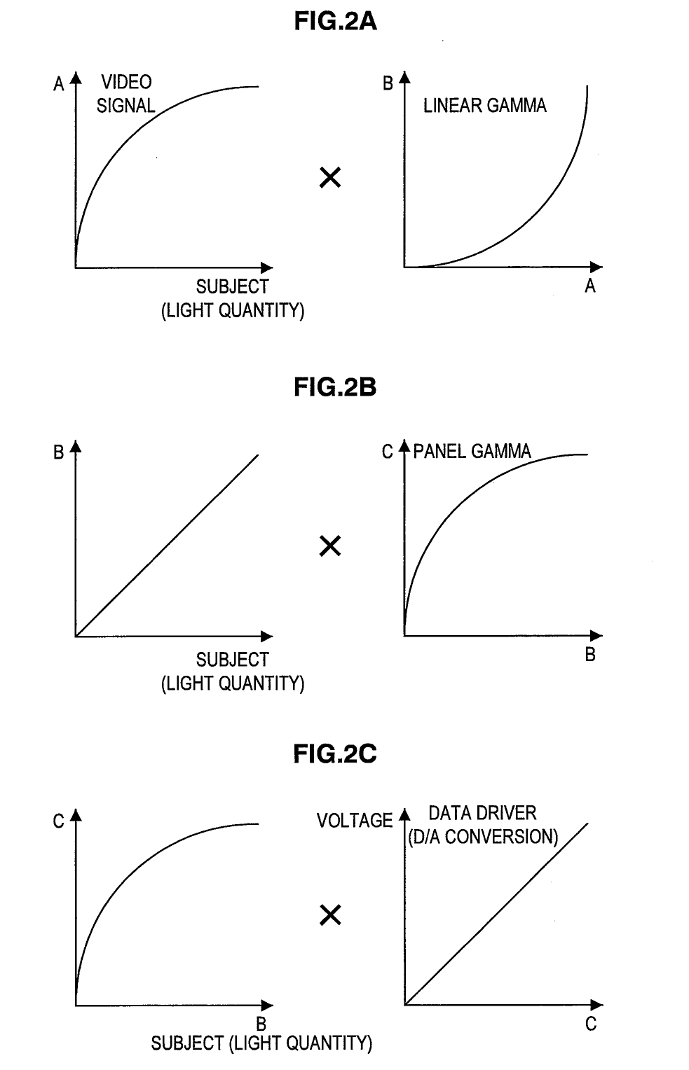

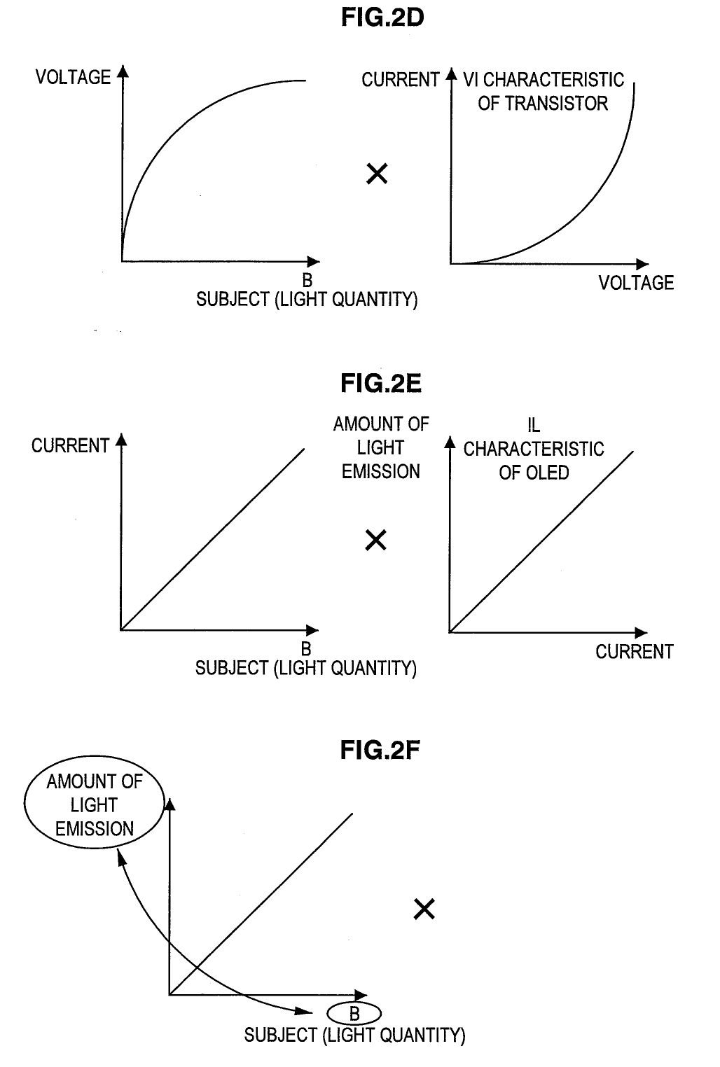

Next, a characteristic transition of a signal flowing in the display device 100 according to the embodiment of the present invention is described below. FIGS. 2A through 2F are explanatory diagrams that explain, in the form of graphs, transitions in characteristics of the signal that flows in the display device 100 according to the embodiment of the present invention. In the respective graphs in FIGS. 2A to 2F, the horizontal axis represents input and the vertical axis represents output.

FIG. 2A illustrates that when a subject is input, the linear conversion unit 116 multiplies a video signal whose output A with respect to the light quantity of the subject has a gamma characteristic by an inverse gamma curve (linear gamma) so as to convert the video signal into a video signal whose output with respect to the light quantity of the subject has a linear characteristic.

FIG. 2B illustrates that the gamma conversion unit 132 multiplies a video signal converted so that an output B with respect to the input of the light quantity of the subject has a linear characteristic by a gamma curve, so as to convert the video signal into a video signal whose output with respect to the input of the light quantity of the subject has a gamma characteristic.

FIG. 2C illustrates that the data driver 152 performs D/A conversion of a video signal, which is converted so that an output C with respect to the input of the light quantity of the subject has the gamma characteristic, into an analog signal. In the D/A conversion, a relationship between input and output has the linear characteristic. Consequently, the data driver 152 performs D/A conversion on a video signal, and when the light quantity of the subject is input, an output voltage has the gamma characteristic.

FIG. 2D illustrates that when the video signal which was subject to the D/A conversion is input into a transistor included in the panel 158, both gamma characteristics are canceled. The VI characteristic of the transistor is the gamma characteristic which has a curve inverse to a gamma characteristic of the output voltage with respect to the input of the light quantity of the subject. Consequently, when the light quantity of the subject is input, the conversion can be again carried out so that the output current has a linear characteristic.

FIG. 2E illustrates that when the light quantity of the subject is input, the signal whose output current has a linear characteristic is input into the panel 158, and the signal having the linear characteristic is multiplied by the IL characteristic of the organic EL elements having the linear characteristic.

As a result, as shown in FIG. 2F, when the light quantity of the subject is input, the amount of light emission of the panel (OLED; Organic Light Emitting Diode) has the linear characteristic, and thus by converting the video signal in the linear conversion unit 116 so as to have a linear characteristic, it becomes possible to perform signal processing on the interval to the gamma conversion unit 132 from the linear conversion unit 116 in the signal processing integrated circuit 110 shown in FIG. 1 as a linear region.

The characteristic transitions of the signals flowing in the display device 100 according to the embodiment of the present invention have been described above.

Pixel Circuit Structure

Next, one example of the structure of the pixel circuit disposed in the panel 158 that is shown in FIG. 1 will be described.

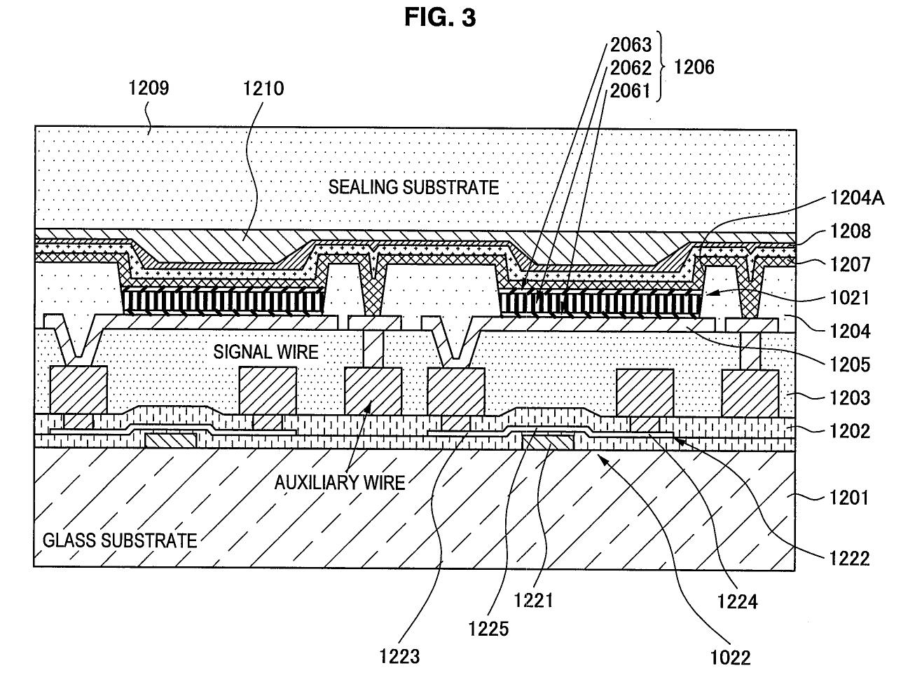

FIG. 3 is a cross-sectional view depicting one example of cross-sectional structure of the pixel circuit disposed in the panel 158 that is shown in FIG. 1. As shown in FIG. 3, the pixel circuit disposed in the panel 158 has a structure in which an insulation film 1202, an insulation leveling film 1203, and a window insulation film 1204 are formed in that order on a glass substrate 1201 in which is formed a drive circuit including a drive transistor 1022 and the like, and an organic EL element 1021 is disposed in a concavity 1204A in the window insulation film 1204. Here, of the respective structural elements of the drive circuit, only the drive transistor 1022 is depicted, and indication of other structural elements is omitted.

The organic EL element 1021 is made up of an anode electrode 1205 composed of metal or the like formed on a bottom portion of the concavity 1204A in the window insulation film 1205, an organic layer (electron transport layer, light emission layer, and hole transport layer/hole implantation layer) 1206 formed on the anode electrode 1206, and a cathode electrode 1207 made up of a transparent conductive film or the like formed commonly on all pixels on the organic layer 1206.

In this organic EL element 1021, the organic layer 1206 is formed by sequentially depositing a hole transport layer/hole implantation layer 2061, a light emission layer 2062, an electron transport layer 2063, and an electron implantation layer (not illustrated) on the anode electrode 1205. Accordingly, light is emitted when electrons and holes in the light emission layer 2062 in the organic layer 1206 electron hole recombine due to current flowing from the drive transistor 1022 via the anode electrode 1205 to the organic layer 1206, under current drive by the drive transistor 1022.

The drive transistor 1022 is made up of a gate electrode 1221, a source/drain region 1223 disposed on one side of a semiconductor layer 1222, a drain/source region 1224 disposed on the other side of the semiconductor layer 1222, and a channel forming region 1225 of a portion facing the gate electrode 1221 of the semiconductor layer 1222. The source/drain region 1223 is electrically connected to the anode electrode 1205 of the organic EL element 1021 via a contact hole.

Accordingly, as shown in FIG. 3, after the organic EL element 1021 has been formed in pixel units, via the insulation film 1202, the insulation leveling film 1203, and the window insulation film 1204, on the glass substrate 1201 in which is formed the drive circuit including the drive transistor 1022, a sealing substrate 1209 is attached by an adhesive 1210 via a passivation film 1208, and the organic EL element 1021 is sealed by the sealing substrate 1209, forming the panel 158.

Drive Circuit

Next, one example of the structure of the drive circuit disposed in the panel 158 that is shown in FIG. 1 will be described.

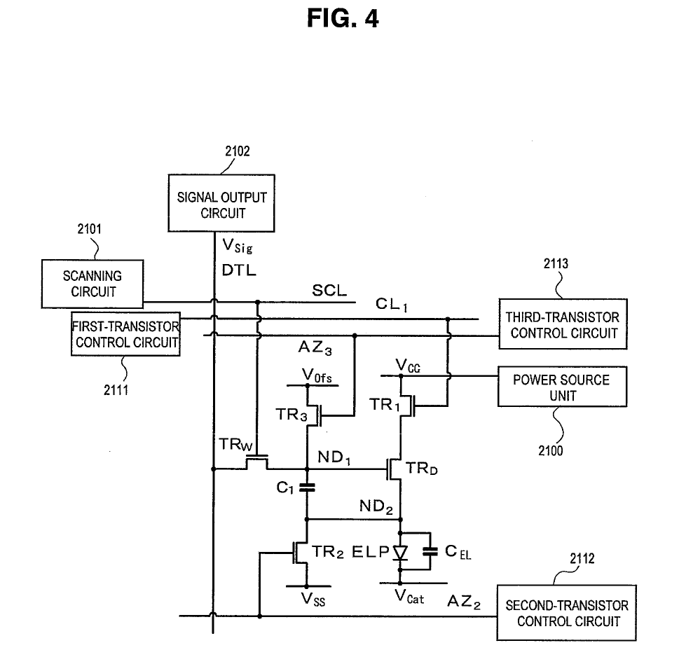

Various circuits that are shown in FIG. 4 and the like exist as drive circuits for driving a light emission unit ELP provided with organic EL elements, but items common to a drive circuit fundamentally made up of five transistors/one capacitor (which hereinafter may in some cases be called a 5Tr/1C drive circuit), a drive circuit fundamentally made up of four transistors/one capacitor (which hereinafter may in some cases be called a 4Tr/1C drive circuit), a drive circuit fundamentally made up of three transistors/one capacitor (which hereinafter may in some cases be called a 3Tr/1C drive circuit), and a drive circuit fundamentally made up of two transistors/one capacitor (which hereinafter may in some cases be called a 2Tr/1C drive circuit) will firstly be explained below.

For convenience, each transistor constituting a drive circuit is, in principle, described as being made up of an n-channel type thin film transistor (TFT). Note, however, that depending on the case, a portion of the transistors can also be made up of p-channel type TFTs. Note that a structure in which transistors are formed on a semiconductor substrate or the like can also be used. The structure of the transistors constituting the drive circuit is not particularly limited. In the explanation below, transistors constituting drive circuits are described as being of enhancement type, but are not limited to this. Depression type transistors may be used. Additionally, transistors constituting a drive circuit may be of single-gate type, or may be of dual-gate type.

In the explanation below, a display device is made up of (N/3)×M pixels arranged in a two-dimensional matrix pattern, and one pixel is taken to be made up of three sub-pixels (a red light emitting sub-pixel that emits red light, a green light emitting sub-pixel that emits green light, and a blue light emitting sub-pixel that emits blue light). Additionally, the light emitting elements constituting each pixel are taken to be driven in line sequence, and a display frame rate is taken to be FR (times/second). That is to say, (N/3) pixels arranged in an mth column (where m=1, 2, 3, . . . , M), or more specifically, light emitting elements respectively made up of N sub-pixels, are driven simultaneously. To state this differently, in respective light emitting elements constituting one column, timing of their light emission/light nonemission is controlled by the unit of the column to which they belong. Note that processing for writing a video signal with regard to respective pixels making up one column may be processing to write a video signal for all pixels simultaneously (which hereinafter may in some cases be called simply simultaneous write processing), or may be processing to write a sequential video signal for each respective pixel (which hereinafter may in some cases be called simply sequential write processing). Which write processing is used may be suitable selected according to the structure of the drive circuit.

Here, in principle, drive and operation relating to a light emitting element posited at an mth column and nth row (where n=1, 2, 3, . . . , N) are described, but such a light emitting element refers, hereinafter, to an (n, m)th light emitting element or (n, m)th sub-pixels. Accordingly, various processing (threshold voltage cancel processing, write processing, and mobility correction processing, described later) is performed until a horizontal scanning period of respective pixels arranged in the mth column (mth horizontal scanning period) ends. Note that performing write processing and mobility correction processing within the mth horizontal scanning period is necessary. On the other hand, depending on the type of the drive circuit, threshold voltage cancel processing and preprocessing accompanying this can be performed in advance of the mth horizontal scanning period.

Accordingly, after the various processing described above has finished completely, light emission units constituting the respective light emitting elements arranged in the mth column are caused to emit light. Note that after the various processing described above has finished completely, the light emission units may be caused to emit light immediately, or the light emission units may be caused to emit light after a predetermined period (for example, a predetermined horizontal scanning period for several columns) has elapsed. This predetermined period can be set suitably according to a specification of the display device or structure or the like of the drive circuit. Note that in the explanation below, for convenience of explanation, the light emission unit is taken to be caused to emit light immediately after the various types of processing finish. Accordingly, light emission of the light emission units constituting the respective light emitting elements arranged in the mth column is continued until just before the start of a horizontal scanning period of respective light emitting elements arranged in an (m+m′) th column. Here, “m′” is determined according to a setting specification of the display device. That is to say, light emission of light emission units constituting respective light emitting elements arranged in an mth column in a given display frame is continued until an (m+m′−1) th horizontal scanning period. On the other hand, light emission units constituting respective light emitting elements arranged in an mth column are in principle maintained in a light nonemission state from a start period of an (m+m′)th horizontal scanning period until write processing and mobility correction processing within an mth horizontal scanning period in the subsequent display frame are completed. By establishing a period of the above-described light nonemission state (which hereinafter may in some cases be called simply a light nonemission period), afterimage blur accompanying active-matrix drive is reduced, and moving-image quality can be made more excellent. Note, however, that the light emission/light nonemission state of respective sub-pixels (light emitting elements) is not limited to the state described above. Additionally, the time length of the horizontal scanning period is a time length of less than (1/FR)×(1/M) seconds. In a case where the value of (m+m′) exceeds M, the horizontal scanning period of the exceeding amount is processed in the next display frame.

In two source/drain regions having one transistor, the term “source/drain region of one side” may in some cases be used with the meaning of a source/drain region on a side connected to an electric power source unit. Additionally, a transistor being in an “on” state signifies a state in which a channel has been formed between source/drain regions. Whether or not current flows from the source/drain region of one side of the transistor to the source/drain region of the other side is immaterial. On the other hand, a transistor being in an “off” state signifies a state in which a channel has not been formed between source/drain regions. Additionally, a source/drain region of a given transistor being connected to a source/drain region of another transistor includes a mode in which the source/drain region of the given transistor and the source/drain region of the other transistor occupy the same region. Further, a source/drain region can be constituted not only by impurity-containing polysilicon or amorphous silicon or the like, but can be constituted by a metal, an alloy, electrically conductive particles, a layered structure of these, or layers made up of an organic material (an electrically conductive polymer). Additionally, in timing charts used in the explanation below, length of a horizontal axis indicating each period is schematic, and does not indicate a proportion of time length of each period.

A drive method of a light emission unit ELP employed in a drive circuit indicated in FIG. 4 or the like is made up of steps of, for example:

(a) performing preprocessing to apply a first node ND₁ initialization voltage to a first node ND₁ and to apply a second node ND₂ initialization voltage to a second node ND₂ so that an electric potential difference between the first node ND₁ and the second node ND₂ exceeds a threshold voltage of a drive transistor TR_{D}, and moreover an electric potential difference between the second node ND₂ and a cathode electrode disposed on a light emission unit ELP does not exceed a threshold voltage of the light emission unit ELP, and subsequently,

(b) performing, in a state where the electric potential of the first node ND₁ is maintained, threshold voltage cancel processing to change the electric potential of the second node ND₂ toward an electric potential obtained by subtracting the threshold voltage of the drive transistor TR_{D} from the electric potential of the first node ND₁, and thereafter,

(c) performing write processing to apply a video signal from a data line DTL to the first node ND₁ via a write transistor TR_{W} switched to an “on” state by a signal from a scanning line SCL, and subsequently,

(d) driving the light emission unit ELP by putting the first node ND₁ in a floating state by switching the write transistor TR_{W} to an “off” state by the signal from the scanning line SCL, and causing current to flow to the light emission unit ELP from an electric power source unit 2100 via the drive transistor TR_{D} according to the value of the electric potential between the first node ND₁ and the second node ND₂.

As was described above, the step (b) performs, in a state where the electric potential of the first node ND₁ is maintained, threshold voltage cancel processing to change the electric potential of the second node ND₂ toward an electric potential obtained by subtracting the threshold voltage of the drive transistor TR_{D} from the electric potential of the first node ND₁. More specifically, to change the electric potential of the second node ND₂ toward an electric potential obtained by subtracting the threshold voltage of the drive transistor TR_{D} from the electric potential of the first node ND₁, voltage exceeding a voltage which is the threshold voltage of the drive transistor TR_{D} added to the electric potential of the second node ND₂ in the step (a) is applied to the source/drain region of one side of the drive transistor TR_{D}. Qualitatively, in the threshold voltage cancel processing, the extent at which the electric potential between the first node ND₁ and the second node ND₂ (stated differently, the electric potential between the gate electrode and the source region of the drive transistor TR_{D}) approaches the threshold voltage of the drive transistor TR_{D} is affected by the time of the threshold voltage cancel processing. Consequently, in a mode in which for example sufficiently long time of threshold voltage cancel processing is established, the electric potential of the second node ND₂ reaches an electric potential obtained by subtracting the threshold voltage of the drive transistor TR_{D} from the electric potential of the first node ND₁. Accordingly, the electric potential difference between the first node ND₁ and the second node ND₂ reaches the threshold voltage of the drive transistor TR_{D}, and the drive transistor TR_{D} changes to an “off” state. On the other hand, in a mode in which for example the time of threshold voltage cancel processing is established must unavoidably be set short, a case may occur in which the electric potential between the first node ND₁ and the second node ND₂ becomes larger than the threshold voltage of the drive transistor TR_{D}, and the drive transistor TR_{D} does not change to an “off” state. The drive transistor TR_{D} need not necessarily change to an “off” state as a result of threshold voltage cancel processing.

Next, drive circuit structure of each respective drive circuit and a drive method of a light emission unit ELP employed in these drive circuits will be explained in detail hereinafter.

5Tr/1C Drive Circuit

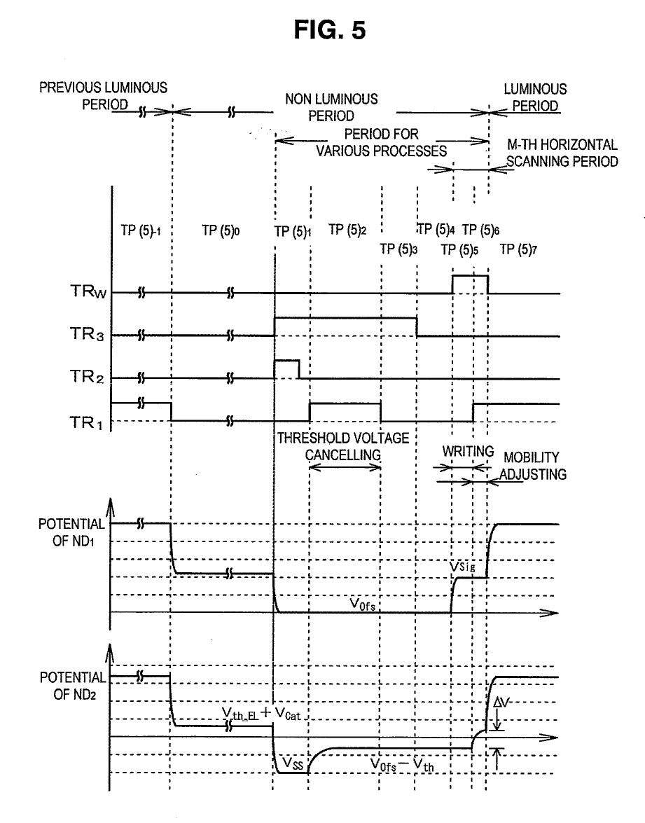

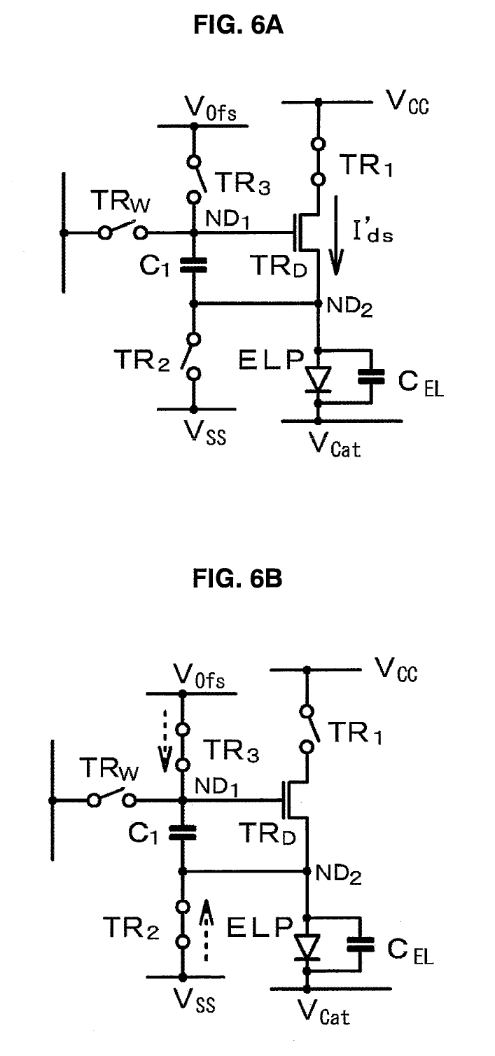

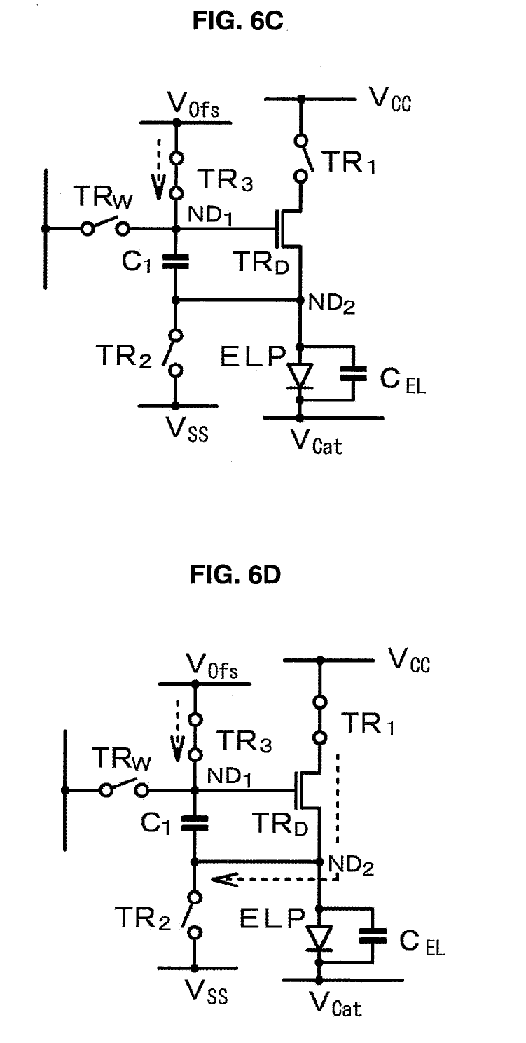

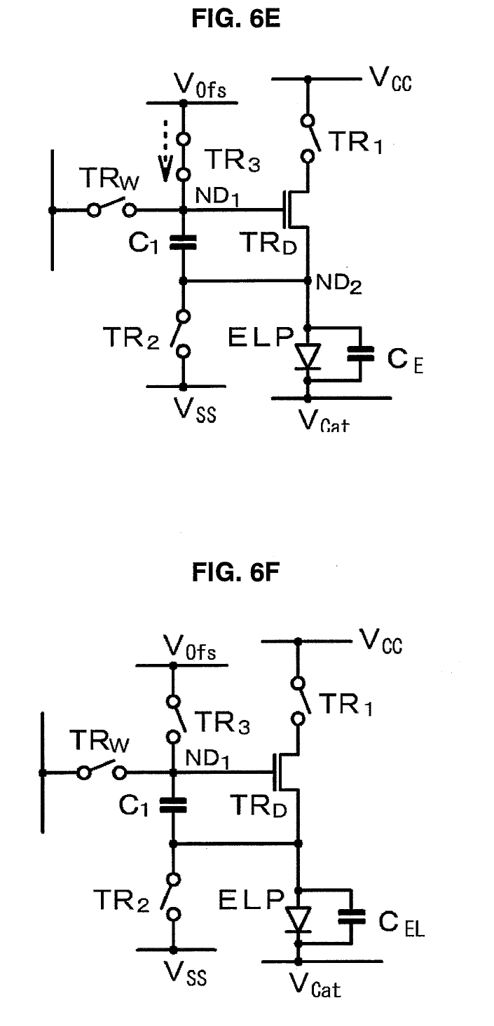

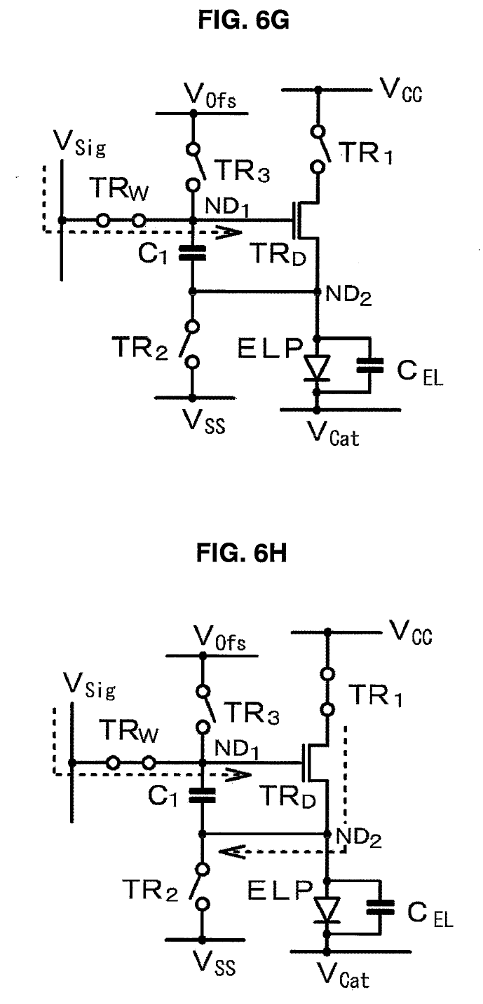

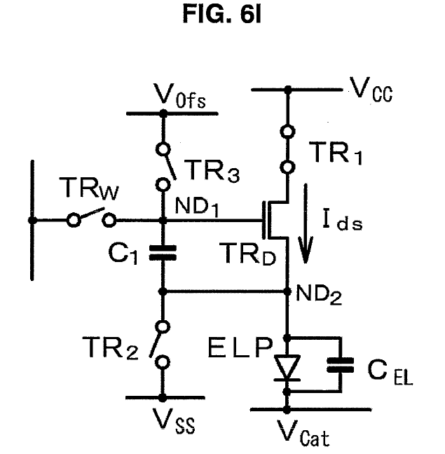

An equivalent circuit diagram of a 5Tr/1C drive circuit is depicted in FIG. 4, a timing chart of drive of the 5Tr/1C drive circuit illustrated in FIG. 4 is depicted schematically in FIG. 5, and on/off states and the like of each transistor of the 5Tr/1C drive circuit are depicted schematically in FIG. 6A through FIG. 6I.

This 5Tr/1C drive circuit is constituted by five transistors: a write transistor TR_{W}, a drive transistor TR_{D}, a first transistor TR₁, a second transistor TR₂, and a third transistor TR₃. It is further constituted by a capacitor C₁. Note that the write transistor TR_{W}, the first transistor TR₁, the second transistor TR₂, and the third transistor TR₃ may be constituted by a p-channel type TFT. Note also that the drive transistor TR_{D} that is shown in FIG. 4 is equivalent to the drive transistor 1022 that is shown in FIG. 3.

First Transistor TR₁

A source/drain region of one side of the first transistor TR₁ is connected to the electric power source unit 2100 (voltage V_{CC}), and a source/drain region of another side of the first transistor TR₁ is connected to a source/drain region of one side of the drive transistor TR_{D}. Additionally, on/off operation of the first transistor TR₁ is controlled by a first transistor control line CL₁ extending from a first transistor control circuit 2111 and connected to a gate electrode of the first transistor TR₁. The electric power source unit 2100 is provided to supply current to a light emission unit ELP and cause the light emission unit ELP to emit light.

Drive Transistor TR_{D}

The source/drain region of one side the drive transistor TR_{D}, as was described above, is connected to the source/drain region of the other side of the first transistor TR₁. On the other hand, the source/drain region of the other side of the drive transistor TR_{D} is connected to:

(1) an anode electrode of the light emission unit ELP,

(2) a source/drain region of another side of the second transistor TR₂, and

(3) one electrode of the capacitor C₁,

and makes up the second node ND₂. Additionally, the gate electrode of the drive transistor TR_{D} is connected to:

(1) a source/drain region of another side of the write transistor TR_{W},

(2) a source/drain region of another side of the third transistor TR₃, and

(3) another electrode of the capacitor C₁,

and makes up the first node ND₁.

Here, the drive transistor TR_{D}, in a light emission state of a light emitting element, is driven according to equation (1) hereinafter so as to cause a drain current I_{ds} to flow. In the light emission state of the light emitting element, the source/drain region on one side of the drive transistor TR_{D} functions as a drain region, and the source/drain region of the other side functions as a source region. For convenience of explanation, in the explanation hereinafter, in some cases the source/drain region of one side of the drive transistor TR_{D} may be called simply the drain region, and the source/drain region of the other side may be called the source region. Note that:

μ: effective mobility

L: channel length

W: channel width

V_{gs}: electric potential between gate electrode and source region

Vₜₕ: threshold voltage

Cₒₓ: (relative permittivity of gate insulation layer)×(electric constant)/(thickness of gate insulation layer)

k≡(½)·(W/L)·Cₒₓ

is taken to hold.

I_{ds}=k·μ·(V_{gs}−Vₜₕ)² (1)

The light emission unit ELP emits light due to this drain current I_{ds} flowing through the light emission unit ELP. The light emission state (luminance) of the light emission unit ELP is controlled by the size of the value of this drain current I_{ds}.

Write transistor TR_{w}

The source/drain region of the other side of the write transistor TR_{W}, as was described above, is connected to the gate electrode of the drive transistor TR_{D}. On the other hand, a source/drain region of one side of the write transistor TR_{W} is connected to a data line DTL extending from a signal output circuit 2102. Accordingly, a video signal V_{Sig} for controlling luminance at the light emission unit ELP is supplied to the source/drain region of one side via the data line DTL. Note that various signals or voltages (signals or various reference voltages or the like for precharge drive) other than V_{Sig} may be supplied to the source/drain region of one side via the data line DTL. Additionally, on/off operation of the write transistor TR_{W} is controlled by a scanning line SCL extending from a scanning circuit 2101 and connected to the gate electrode of the write transistor TR_{W}.

Second Transistor TR₂

The source/drain region of the other side of the second transistor TR₂, as was described above, is connected to the source region of the drive transistor TR_{D}. On the other hand, voltage V_{SS} for initializing the electric potential of the second node ND₂ (that is to say, the electric potential of the source region of the drive transistor TR_{D}) is supplied to the source/drain region of one side of the second transistor TR₂. Additionally, on/off operation of the second transistor TR₂ is controlled by a second transistor control line AZ₂ extending from a second transistor control circuit 2112 and connected to the gate electrode of the second transistor TR₂.

Third Transistor TR₃

The source/drain region of the other side of the third transistor TR₃, as was described above, is connected to the gate electrode of the drive transistor TR_{D}. On the other hand, voltage V_{0fs} for initializing the electric potential of the first node ND₁ (that is to say, the electric potential of the gate electrode of the drive transistor TR_{D}) is supplied to the source/drain region of one side of the third transistor TR₃. Additionally, on/off operation of the third transistor TR₃ is controlled by a third transistor control line AZ₃ extending from a third transistor control circuit 2113 and connected to the gate electrode of the third transistor TR₃.

Light Emission Unit ELP

The anode electrode of the light emission unit ELP, as was described above, is connected to the source region of the drive transistor TR_{D}. On the other hand, voltage V_{Cat} is applied to the cathode electrode of the light emission unit ELP. Capacitance of the light emission unit ELP is indicated by a symbol C_{EL}. Additionally, threshold voltage taken to be necessary for light emission of the light emission unit ELP is taken to be V_{th-EL}. That is to say, when voltage of V_{th-EL} or more is applied between the anode electrode and the cathode electrode of the light emission unit ELP, the light emission unit ELP emits light.

In the explanation hereinafter, values of voltage or electric potential are as shown below, but these are only values for explanation, and there is no limitation to these values.

V_{Sig}: Video signal for controlling luminance at the light emission unit ELP
0 volts to 10 volts

V_{CC}: Voltage of the electric power source unit 2100
20 volts

V_{0fs}: Voltage for initializing the electric potential of the gate electrode of the drive transistor TR_{D} (the electric potential of the first node ND₁)
0 volts

V_{SS}: Voltage for initializing the electric potential of the source region of the drive transistor TR_{D} (the electric potential of the second node ND₂)
−10 volts

Vₜₕ: Threshold voltage of the drive transistor TR_{D}
3 volts

V_{Cat}: Voltage applied to the cathode electrode of the light emission unit ELP
0 volts

V_{th-EL}: Threshold voltage of the light emission unit ELP
3 volts

Operation of the 5Tr/1C drive circuit will be described hereinafter. Note that, as was described above, it is described that a light emission state is taken to begin immediately after the various types of processing (threshold voltage cancel processing, write processing, and mobility correction processing) have finished, but there exists no limitation to this. This is similar for the 4Tr/1C drive circuit, 3Tr/1C drive circuit, and 2Tr/1C drive circuit that will be described later.

Period−TP (5)₄ (Refer to FIG. 5 and FIG. 6A)

This [period−TP (5)₄] is for example operation in a previous display frame, and is a period in which the (n, m)th light emitting elements after completion of the previous various types of processing are in the light emission state. That is to say, drain current I′_{ds} flows to in the light emission unit ELP in the light emitting elements making up the (n, m)th sub-pixels on a basis of equation (5) described later, and luminance of the light emission unit ELP in the light emitting elements making up the (n, m)th sub-pixels is a value corresponding to the drain current I′_{ds}. Here, the write transistor TR_{W}, the second transistor TR₂, and the third transistor TR₃ are in an “off” state, and first transistor TR₁ and drive transistor TR_{D} are in an “on” state. The light emission state of the (n, m)th light emitting elements is continued until immediately before the start of the horizontal scanning period of the light emitting elements arranged in the (m+m′) th column.

[Period−TP (5)₀] through [period−TP (5)₄] depicted in FIG. 5 are an operation period from after the light emission state after completion of the previous various types of processing until immediately before the next write processing is performed. That is to say, this [period−TP (5)₀] through [period−TP (5)₄] is a period of given time length for example from the start period of the (m+m′) th horizontal scanning period in the previous display frame until the end period of the (m−1) th horizontal scanning period. Note that [period−TP (5)₁] through [period−TP (5)₄] can be taken to be constituted to be included in the mth horizontal scanning period in the present display frame.

Accordingly, in this [period−TP (5)₀] through [period−TP (5)₄], the (n, m)th light emitting elements are in principle in a light nonemission state. That is to say, in [period−TP (5)₀] through [period−TP (5)₁] and [period−TP (5)₃] through [period−TP (5)₄], the first transistor TR₁ is in an “off” state, and thus the light emitting elements do not emit light. Note that in [period−TP (5)₂], the first transistor TR₁ is in an “on” state. However, in this period, threshold voltage cancel processing described later is performed. As will be described in detail in the explanation of threshold voltage cancel processing, if it is assumed that equation (2) described later is satisfied, the light emitting elements do not emit light.

The respective periods of [period−TP (5)₀] through [period−TP (5)₄] are firstly described hereinafter. Note that the lengths of the start period of [period−TP (5)₁] and the respective periods of [period−TP (5)₁] through [period−TP (5)₄] may be set suitably in accordance with the design of the display device.

Period−TP (5)₀

As was described above, in [period−TP (5)₀], the (n, m)th light emitting elements are in a light emission state. The write transistor TR_{W}, the second transistor TR₂, and the third transistor TR₃ are in an “off” state. Additionally, at the time of transition from [period−TP (5)_{—}1] to [period−TP (5)₀], because the first transistor TR₁ changes to an “off” state, the electric potential of the second node ND₂ (the source region of the drive transistor TR_{D} or the anode electrode of the light emission unit ELP) falls to (V_{th-EL}+V_{Cat}), and light emission unit ELP changes to a light nonemission state. Additionally, the electric potential of the first node ND₁ (the gate electrode of the drive transistor TR_{D}) in a floating state also falls, so as to follow the fall in the electric potential of the second node ND₂.

Period−TP (5)₁ (Refer to FIG. 6B and FIG. 6C)

In this [period−TP (5)₁], preprocessing for performing threshold voltage cancel processing described later is performed. That is to say, at the start of [period−TP (5)₁], the second transistor TR₂ and the third transistor TR₃ are put in an “on” state by putting the second transistor control line AZ₂ and the third transistor control line AZ₃ at high level. As a result of this, the electric potential of the first node ND₁ changes to V_{0fs} (for example, 0 volts). On the other hand, the electric potential of the second node ND₂ changes to V_{SS} (for example, −10 volts). Accordingly, prior to completion of this [period−TP (5)₁], the second transistor TR₂ is put in an “off” state by putting the second transistor control line AZ₂ at low level. Note that the second transistor TR₂ and the third transistor TR₃ may be put in an “on” state simultaneously, the second transistor TR₂ may be put in an “on” state firstly, or the third transistor TR₃ may be put in an “on” state firstly.

Due to the foregoing processing, the electric potential difference between the gate electrode and the source region of the drive transistor TR_{D} becomes Vₜₕ or higher. The drive transistor TR_{D} changes to an “on” state.

Period−TP (5)₂ (Refer to FIG. 6D)

Next, threshold voltage cancel processing is performed. That is to say, the first transistor TR₁ is put in an “on” state by putting the first transistor control line CL₁ at high level while maintaining the third transistor TR₃ in an “on” state. As a result of this, the electric potential of the first node ND₁ does not change (maintaining V_{0fs}=0 volts), and the electric potential of the second node ND₂ changes toward an electric potential obtained by subtracting the threshold voltage Vₜₕ of the drive transistor TR_{D} from the electric potential of the first node ND₁. That is to say, the electric potential of the second node ND₂ in a floating state rises. Accordingly, when the electric potential between the gate electrode and the source region of the drive transistor TR_{D} reaches Vₜₕ, the drive transistor TR_{D} changes to an “off” state. Specifically, the electric potential of the second node ND₂ in a floating state approaches (V_{0fs}−Vₜₕ=−3 volts>V_{SS}), and ultimately becomes (V_{0fs}−Vₜₕ). Here, if equation (2) hereinafter is assured, or to state this differently, if the electric potential is selected and determined so as to satisfy equation (2), the light emission unit ELP does not emit light.

(V_{0fs}−Vₜₕ)<(Vₜₕ−EL+V_{Cat}) (2)

In this [period−TP (5)₂], the electric potential of the second node ND₂ ultimately becomes (V_{0fs}−Vₜₕ). That is to say, the electric potential of the second node ND₂ is determined dependent solely on the threshold voltage Vₜₕ of the drive transistor TR_{D} and the voltage V_{0fs} for initializing the gate electrode of the drive transistor TR_{D}. Stated differently, there is no dependence on the threshold voltage V_{th-EL} of the light emission unit ELP.

Period−TP (5)₃ (Refer to FIG. 6E)

Thereafter, the first transistor TR₁ is put in an “off” state by putting the first transistor control line CL₁ at low level while maintaining the third transistor TR₃ in an “on” state. As a result of this, the electric potential of the first node ND₁ is held unchanged (maintaining V_{0fs}=0 volts) and the electric potential of the second node ND₂ also is held unchanged (V_{0fs}−Vₜₕ=−3 volts).

Period−TP (5)₄ (Refer to FIG. 6F)

Next, the third transistor TR₃ is put in an “off” state by putting the third transistor control line AZ₃ at low level. As a result of this, the electric potentials of the first node ND₁ and the second node ND₂ substantially do not change. In actuality, changes can occur due to electrostatic coupling of parasitic capacitance or the like, but, normally, these can be ignored.

Next, the respective periods of [period−TP (5)₅] through [period−TP (5)₇] are described. Note that, as is described later, write processing is performed in [period−TP (5)₅], and mobility correction processing is performed in [period−TP (5)₆]. As was described above, performing these sets of processing within the mth horizontal scanning period is necessary. For convenience of explanation, a start period of [period−TP (5)₅] and an end period of [period−TP (5)₆] are explained as coinciding respectively with the start period and the end period of the mth horizontal scanning period.

Period−TP (5)₅] (Refer to FIG. 6G)

Thereafter, write processing is executed with respect to the drive transistor TR_{D}. Specifically, the write transistor TR_{W} is put in an “on” state by putting the electric potential of the data line DTL to the video signal V_{Sig} for controlling the luminance at the light emission unit ELP, and then putting the scanning line SCL at high level, while maintaining an “off” state of the first transistor TR₁, the second transistor TR₂, and the third transistor TR₃. As a result of this, the electric potential of the first node ND₁ rises to V_{Sig}.

Here, capacitance of the capacitor C₁ is indicated by a value c₁, and capacitance of the capacitance C_{EL} of the light emission unit ELP is indicated by a value c_{EL}. Accordingly, the value of parasitic capacitance between the gate electrode and the source region of the drive transistor TR_{D} is taken to be c_{gs}. When the electric potential of the gate electrode of the drive transistor TR_{D} has changed from V_{0fs} to V_{Sig} (>V_{0fs}), the electric potentials of the two ends of the capacitor C₁ (the electric potentials of the first node ND₁ and the second node ND₂), in principle, change. That is to say, an electric charge based on the amount of change (V_{Sig}−V_{0fs}) in the electric potential of the gate electrode of the drive transistor TR_{D} (=the electric potential of the first node ND₁) is allocated to capacitor C₁, the capacitance C_{EL} of the light emission unit ELP, and the parasitic capacitance between the gate electrode and the source region of the drive transistor TR_{D}. However, if the value c_{EL} is sufficiently large in comparison with the value c₁ and the value c_{gs}, change is small for the electric potential of the source region (second node ND₂) of the drive transistor TR_{D} based on the amount of change (V_{Sig}−V_{0fs}) in the electric potential of the gate electrode of the drive transistor TR_{D}. Accordingly, generally, the capacitance value c_{EL} of the capacitance C_{EL} of the light emission unit ELP is larger than the capacitance value c₁ of the capacitor C₁ and the value c_{gs} of the parasitic capacitance of the drive transistor TR_{D}. In this regard, for convenience of explanation, except in cases where there is special need, explanation is given without consideration for change in the electric potential of the second node ND₂ occurring due to change in the electric potential of the first node ND₁. This is similar for other drive circuits as well. Note that in the timing chart of drive depicted in FIG. 5 as well, depiction is made without consideration for change in the electric potential of the second node ND₂ occurring due to change in the electric potential of the first node ND₁. When the electric potential of the gate electrode (first node ND₁) of the drive transistor TR_{D} is taken to be V_{g} and the electric potential of the source region (second node ND₂) of the drive transistor TR_{D} is taken to be Vₛ, the value of V_{g} and the value of Vₛ change as indicated below. Thus, the electric potential difference of the first node ND₁ and the second node ND₂, or in other words, the electric potential difference V_{gs} between the gate electrode and the source region of the drive transistor TR_{D}, can be expresses by equation (3) below.

V_{g}=V_{Sig}

Vₛ V_{0fs}=Vₜₕ

V_{gs} V_{Sig}−(V_{0fs}−Vₜₕ) (3)

That is to say, V_{gs}, obtained by write processing with respect to the drive transistor TR_{D}, is dependent solely on the video signal V_{Sig} for controlling luminance at the light emission unit ELP, the threshold voltage Vₜₕ of the drive transistor TR_{D}, and the voltage V_{0fs} for initializing the electric potential of the source region of the drive transistor TR_{D}. Accordingly, it is unrelated to the threshold voltage V_{th-EL} of the light emission unit ELP.

Period−TP (5)₆ (Refer to FIG. 6H)

Thereafter, correction (mobility correction processing) of the electric potential of the source region (second node ND₂) of the drive transistor TR_{D} is performed on a basis of the size of the mobility t of the drive transistor TR_{D}.

Generally, when the drive transistor TR_{D} has been fabricated from a polysilicon film transistor or the like, occurrence of variation in the mobility t between transistors is difficult to avoid. Consequently, even when a video signal V_{Sig} having an identical value are applied to the gate electrodes of a plurality of drive transistors TR_{D} in which differences in the mobility μ exist, differences occur between the drain current I_{ds} flowing through drive transistors TR_{D} having a large mobility t and the drain current I_{ds} flowing through drive transistors TR_{D} having a small mobility μ. Accordingly, when this kind of difference occurs, uniformity of the screen of the display device is lost.

Consequently, specifically, the first transistor TR₁ is put into an “on” state by putting the first transistor control line CL₁ at high level while maintaining an “on” state of the drive transistor TR_{W}, and subsequently, after a predetermined time (t₀) has elapsed, the write transistor TR_{W} is put in an “off” state and the first node ND₁ (the gate electrode of the drive transistor TR_{D}) is put in a floating state by putting the scanning line SCL at low level. Accordingly, in a case where the value of the mobility μ of the drive transistor TR_{D} becomes large as a result of the foregoing, a rise quantity ΔV (electric potential correction value) of the electric potential at the source region of the drive transistor TR_{D} becomes large, and in a case where the value of the mobility t of the drive transistor TR_{D} becomes small as a result of the foregoing, the rise quantity ΔV (electric potential correction value) of the electric potential at the source region of the drive transistor TR_{D} becomes small. Here, the electric potential difference V_{gs} between the gate electrode and the source region of the drive transistor TR_{D} is transformed from equation (3) to equation (4) below.

V_{gs} V_{Sig}−(V_{0f1}−Vₜₕ)−ΔV (4)

Note that the predetermined time (total time t₀ of [period−TP (5)₆]) for executing mobility correction processing may, during design of the display device, be priorly determined as a design value. Additionally, the total time t₀ of [period−TP (5)6] is determined so that the electric potential (V_{0f1}−Vₜₕ+ΔV) at the source region of the drive transistor TR_{D} at this time satisfies equation (2′) below. Accordingly, due to this, the light emission unit ELP does not emit light in [period−TP (5)₆]. Further, correction of variation in a coefficient k(≡(½)·(W/L)·Cₒₓ) also is performed simultaneously by this mobility correction processing.

(V_{0fs}−Vₜₕ+ΔV)<(V_{th-EL}+V_{Cat}) (2′)

Period−TP (5)₇ (Refer to FIG. 6I)

Threshold-voltage cancel processing, write processing, and mobility correction processing are completed by the foregoing operations. As an incidental comment, as a result of the scanning line SCL changing to low level, the write transistor TR_{W} changes to an “off” state and the first node ND₁, that is to say, the gate electrode of the drive transistor TR_{D}, changes to a floating state. On the other hand, the first transistor TR₁ maintains an “on” state, and the drain region of the drive transistor TR_{D} is in a state of connection to the electric power source unit 2100 (voltage V_{CC}, for example 20 volts). Consequently, as a result of the foregoing, the electric potential of the second node ND₂ rises.

Here, as was described above, the gate electrode of the drive transistor TR_{D} is in a floating state, and moreover, because the capacitor C₁ exists, a phenomenon similar to that in what is known as a bootstrap circuit occurs at the gate electrode of the drive transistor TR_{D}, and the electric potential of the first node ND₁ also rises. As a result, the electric potential difference V_{gs} between the gate electrode and the source region of the drive transistor TR_{D} maintains the value of equation (4).

Additionally, the electric potential of the second node ND₂ rises and exceeds (V_{th-EL}+V_{Cat}), and thus the light emission unit ELP starts to emit light. At this time, the current flowing through the light emission unit ELP is the drain current I_{ds} flowing from the drain region of the drive transistor TR_{D} to the source region of the drive transistor TR_{D}, and thus can be expressed by equation (1). Here, based on equation (1) and equation (4), equation (1) can be transformed into equation (5) below.

I_{ds}=k·μ·(V_{Sig}−V_{0fs}−ΔV)² (5)

Consequently, the drain current I_{ds} flowing through the light emission unit ELP, for example in a case where V_{0fs} has been set at 0 volts, is proportional to the square of the value obtained by subtracting the value of the electric potential correction value ΔV at the second node ND₂ (the source region of the drive transistor TR_{D}) arising from the mobility μ of the drive transistor TR_{D} from the value of the video signal V_{Sig} for controlling the luminance at the light emission unit ELP. Stated differently, the drain current I_{ds} flowing through the light emission unit ELP is not dependent on the threshold voltage V_{th-EL} of the light emission unit ELP or the threshold voltage Vₜₕ of the drive transistor TR_{D}. That is to say, the amount of light emission (luminance) of the light emission unit ELP is not subject to an effect by the threshold voltage V_{th-EL} of the light emission unit ELP or an effect by the threshold voltage Vₜₕ of the drive transistor TR_{D}. Accordingly, the luminance of the (n, m)th light emitting elements is a value that corresponds to the drain current I_{ds}.

Moreover, the larger is the mobility μ of the drive transistor TR_{D}, the larger becomes the electric potential correction value ΔV, and thus the smaller becomes the value of V_{gs} on the left side equation (4). Consequently, in equation (5), as a result of the value of (V_{Sig}−V_{0fs}−ΔV)² becoming small even when the value of the mobility μ is large, the drain current I_{ds} can be corrected. That is to say, even in drive transistors TR_{D} of differing mobility μ, if the value of the video signal V_{Sig} is the same, the drain current I_{ds} comes to be substantially the same, and as a result, the drain current I_{ds} flowing through the light emission unit ELP and controlling the luminance of the light emission unit ELP is made uniform. That is to say, variations in luminance arising from variations in the mobility μ (and moreover, variation in k) can be corrected.

The light emission state of the light emission unit ELP continues until the (m+m′−1)th horizontal scanning period. This time point corresponds to the end of [period−TP (5)₋₁].

Light emission operation of light emitting elements 10 constituting (n, m)th sub-pixels is completed by the foregoing.

Next, an explanation of a 2Tr/1C drive circuit will be made.

2Tr/1C Drive Circuit

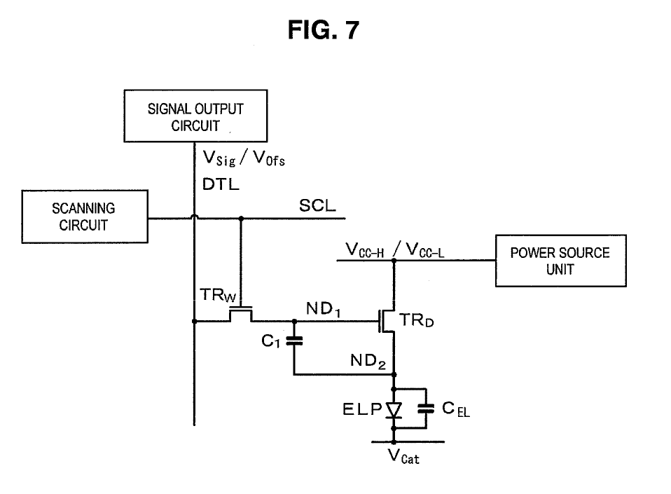

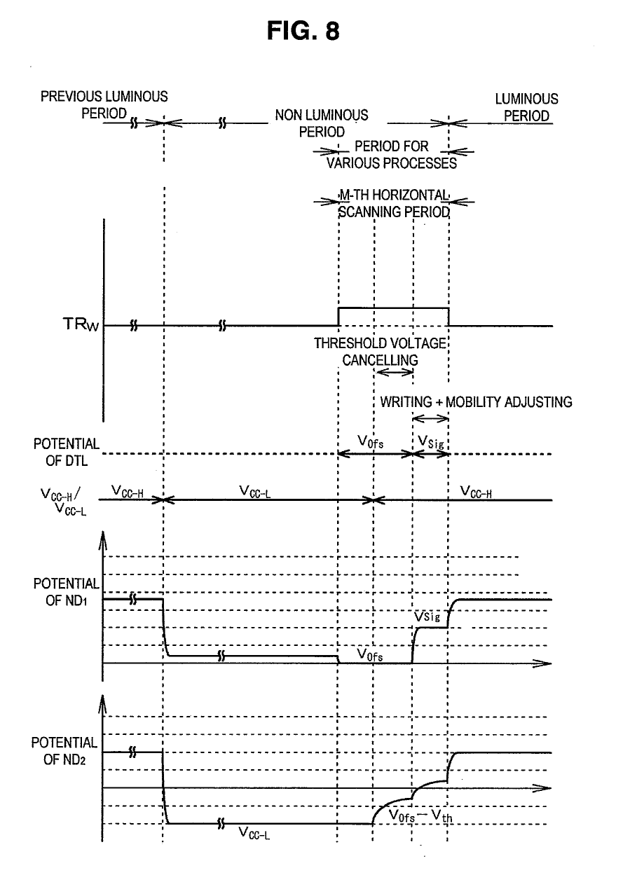

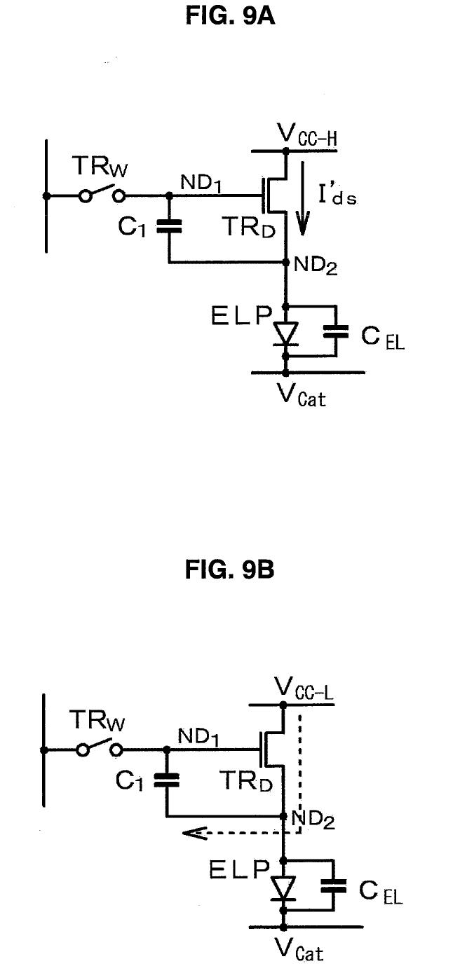

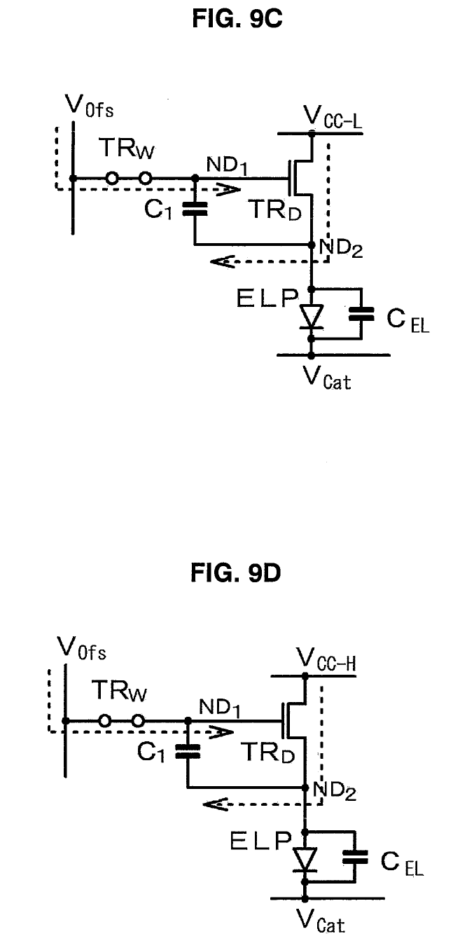

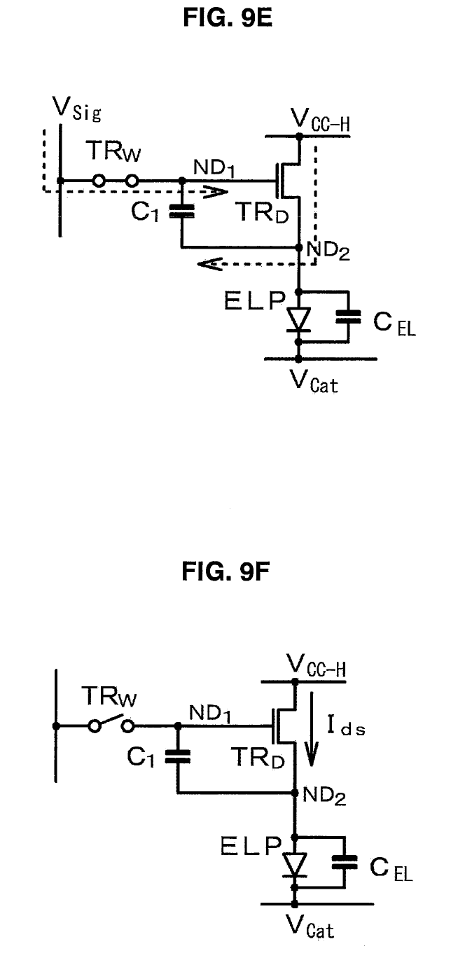

An equivalent circuit diagram of a 2Tr/1C drive circuit is depicted in FIG. 7, a timing chart of drive is depicted schematically in FIG. 8, and on/off states and the like of each transistor of the 2Tr/1C drive circuit are depicted schematically in FIG. 9A through FIG. 9F.

Three transistors in the above-described 5Tr/1C drive circuit, being the first transistor TR₁, the second transistor TR₂, and the third transistor TR₃, are omitted from this 2Tr/1C drive circuit. That is to say, this 2Tr/1C drive circuit is constituted by two transistors, being a write transistor TR_{W} and a drive transistor TR_{D}, and further is constituted by one capacitor C₁. Note also that the drive transistor TR_{D} that is shown in FIG. 7 is equivalent to the drive transistor 1022 that is shown in FIG. 3.

Drive Transistor TR_{D}

The structure of the drive transistor TR_{D} is the same as the structure of the drive transistor TR_{D} described for the 5Tr/1C drive circuit, and thus detailed explanation is omitted. Note, however, that the drain region of the drive transistor TR_{D} is connected to an electric power source unit 2100. Note also that voltage V_{CC-H} for causing the light emission unit ELP to emit light and voltage V_{CC-L} for controlled the electric potential of the source region of the drive transistor TR_{D} are supplied from the electric power source unit 2100. Here, as values of voltages V_{CC-H} and V_{CC-L},

V_{CC-H}=20 volts

V_{CC-L}=−10 volts

are used by way of example, but there is no limitation to these values.

Write Transistor TR_{w}

The structure of the write transistor TR_{W} is the same as the structure of the write transistor TR_{W} described for the 5Tr/1C drive circuit, and thus detailed explanation is omitted.

Light Emission Unit ELP

The structure of the light emission unit ELP is the same as the structure of the light emission unit ELP described for the 5Tr/1C drive circuit, and thus detailed explanation is omitted.

Operation of the 2Tr/1C drive circuit will be described hereinafter.

Period−TP (2)₋₁ (Refer to FIG. 8 and FIG. 9A)

This [period−TP (2)₋₁] is for example operation in a previous display frame, and is substantially the same operation of [period−TP (5)₋₁] described for the 5Tr/1C drive circuit.

[Period−TP (2)₀] through [period−TP (2)₂] depicted in FIG. 5 are periods corresponding to [period−TP (5)₀] through [period−TP (5)₄] depicted in FIG. 5, and are an operation period until immediately before the next write processing is performed. Accordingly, similarly to the 5Tr/1C drive circuit, in [period−TP (2)₀] through [period−TP (2)₂], the (n, m)th light emitting elements are in principle in a light nonemission state. Note, however, that in the operation of the 2Tr/1C drive circuit, as depicted in FIG. 8, aside from [period−TP (2)₃], the matter of [period−TP (2)₁] through [period−TP (2)₂] also including an mth horizontal scanning period differs from the operation of the 5Tr/1C drive circuit. Not also that for convenience of explanation, a start period of [period−TP (2)₁] and an end period of [period−TP (2)₃] are explained as coinciding respectively with the start period and the end period of the mth horizontal scanning period.

The respective periods of [period−TP (2)₀] through [period−TP (2)₂] are described hereinafter. Note that similarly to what was explained for the 5Tr/1C drive circuit, the lengths of the respective periods of [period−TP (2)₁] through [period−TP (2)₃] may be set suitably in accordance with the design of the display device.

Period−TP (2)₀ (Refer to FIG. 9B)

This [period−TP (2)₀] is for example operation from the previous display frame to the present display frame. That is to say, this [period−TP (2)₀] is the period from the (m+m′)th horizontal scanning period in the previous display frame to the (m−1)th horizontal scanning period in the present display frame. Accordingly, in this [period−TP (2)₀], the (n, m)th light emitting elements are in a light nonemission state. Here, at the time point of change from [period−TP (2)₋₁] to [period−TP (2)₀], the voltage supplied from the electric power source unit 2100 is switched from V_{CC-H} to V_{CC-L}. As a result, the electric potential of the second node ND₂ falls to V_{CC-L}, and the light emission unit ELP changes to a light nonemission state. Accordingly, the electric potential of the first node ND₁ (the gate electrode of the drive transistor TR_{D}) in a floating state also falls, so as to follow the fall in the electric potential of the second node ND₂.

Period−TP (2)₁ (Refer to FIG. 9C)

Accordingly, the mth horizontal scanning period starts in the present display frame. In this [period−TP (2)₁], preprocessing for performing threshold voltage cancel processing is performed. At the time of the start of [period−TP (2)₁], the write transistor TR_{W} is put in an “on” state by putting the scanning line SCL at high level. As a result, the electric potential of the first node ND₁ changes to V_{0fs} (for example, 0 volts). The electric potential of the second node ND₂ maintains V_{cC-L} (for example, −10 volts).

Due to the above-described operation, the electric potential difference between the gate electrode and the source region of the drive transistor TR_{D} becomes Vₜₕ or higher, and the drive transistor TR_{D} changes to an “on” state.

Period−TP (2)₂ (Refer to FIG. 9D)

Next, threshold voltage cancel processing is performed. That is to say, the voltage supplied from the electric power source unit 2100 is switched from V_{CC-L} to V_{CC-H} while the “on” state of the write transistor TR_{W} is maintained. As a result of this, the electric potential of the first node ND₁ does not change (maintaining V_{0fs}=0 volts), and the electric potential of the second node ND₂ changes toward an electric potential obtained by subtracting the threshold voltage Vₜₕ of the drive transistor TR_{D} from the electric potential of the first node ND₁. That is to say, the electric potential of the second node ND₂ in a floating state rises. Accordingly, when the electric potential between the gate electrode and the source region of the drive transistor TR_{D} reaches Vₜₕ, the drive transistor TR_{D} changes to an “off” state. Specifically, the electric potential of the second node ND₂ in a floating state approaches (V_{0fs}−Vₜₕ=−3 volts), and ultimately becomes (V_{0fs}−Vₜₕ). Here, if equation (2) hereinafter is assured, or to state this differently, if the electric potential is selected and determined so as to satisfy equation (2), the light emission unit ELP does not emit light.

In this [period−TP (2)₂], the electric potential of the second node ND₂ ultimately becomes (V_{0fs}−Vₜₕ). That is to say, the electric potential of the second node ND₂ is determined dependent solely on the threshold voltage Vₜₕ of the drive transistor TR_{D} and the voltage V_{0fs} for initializing the gate electrode of the drive transistor TR_{D}. Accordingly, there is no relationship with the threshold voltage V_{th-EL} of the light emission unit ELP.

Period−TP (2)₃ (Refer to FIG. 9E)

Next are performed write processing with respect to the drive transistor TR_{D}, and correction (mobility correction processing) of the electric potential of the source region (second node ND₂) of the drive transistor TR_{D} on a basis of the size of the mobility μ of the drive transistor TR_{D}. Specifically, the electric potential of the data line DTL is put to the video signal V_{Sig} for controlling the luminance at the light emission unit ELP while maintaining the “on” state of the write transistor TR_{W}. As a result of this, the electric potential of the first node ND₁ rises to V_{Sig}, and the drive transistor TR_{D} changes to an “on” state. Note that the drive transistor TR_{D} may be put into an “on” state by temporarily putting the write transistor TR_{W} in an “off” state, changing the electric potential of the data line DTL to the video signal V_{Sig} for controlling the luminance at the light emission unit ELP, and thereafter putting the scanning line SCL at high level, putting the write transistor TR_{W} in an “on” state.

Unlike what was explained for the 5Tr/1C drive circuit, electric potential V_{CC-H} is applied to the drain region of the drive transistor TR_{D} from the electric power source unit 2100, and thus the electric potential of the gate electrode of the drive transistor TR_{D} rises. After a predetermined time (t₀) has elapsed, the write transistor TR_{W} is put in an “off” state and the first node ND₁ (the gate electrode of the drive transistor TR_{D}) is put in a floating state by putting the scanning line SCL at low level. Note that the total time t₀ of this [period−TP (2)₃] may, during design of the display device, be priorly determined as a design value such that the electric potential of the second node ND₂ becomes (V_{0fi}−Vₜₕ+ΔV).

In this [period−TP (2)₃], in a case where the value of the mobility μ of the drive transistor TR_{D} is large, the rise quantity ΔV of the electric potential at the source region of the drive transistor TR_{D} is large, and in a case where the value of the mobility μ of the drive transistor TR_{D} is small, the rise quantity ΔV of the electric potential at the source region of the drive transistor TR_{D} is small.

Period−TP (2)₄ (Refer to FIG. 9E)

Threshold-voltage cancel processing, write processing, and mobility correction processing are completed by the foregoing operations. Accordingly, the same processing as [period−TP (5)₇] described for the 5Tr/1C drive circuit is performed, the electric potential of the second node ND₂ rises and exceeds (V_{th-EL}+V_{Cat}), and thus the light emission unit ELP starts to emit light. At this time, the current flowing through the light emission unit ELP can be obtained using equation (5), and thus the drain current I_{ds} flowing through the light emission unit ELP is not dependent on the threshold voltage V_{th-EL} of the light emission unit ELP or the threshold voltage Vₜₕ of the drive transistor TR_{D}. That is to say, the amount of light emission (luminance) of the light emission unit ELP is not subject to an effect by the threshold voltage V_{th-EL} of the light emission unit ELP or an effect by the threshold voltage Vₜₕ of the drive transistor TR_{D}. Moreover, occurrence of variations in the drain current I_{ds} arising from variations in the mobilityμ can be suppressed.

Accordingly, the light emission state of the light emission unit ELP continues until the (m+m′−1) th horizontal scanning period. This time point corresponds to the end of [period−TP (2)₄].

Light emission operation of light emitting elements 10 constituting (n, m)th sub-pixels is completed by the foregoing.

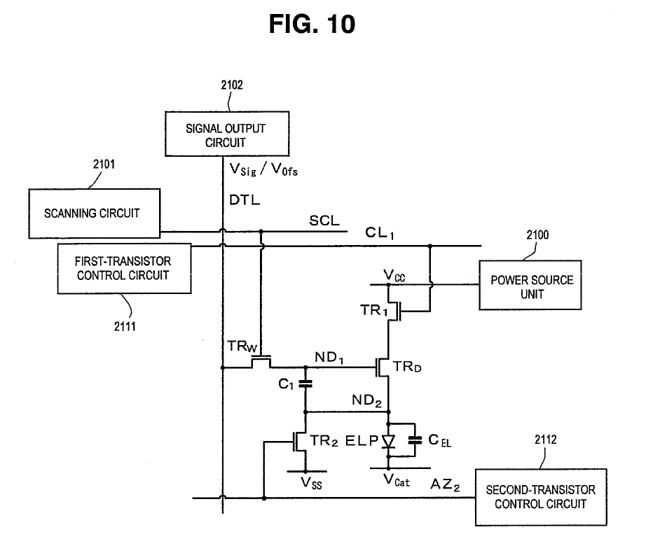

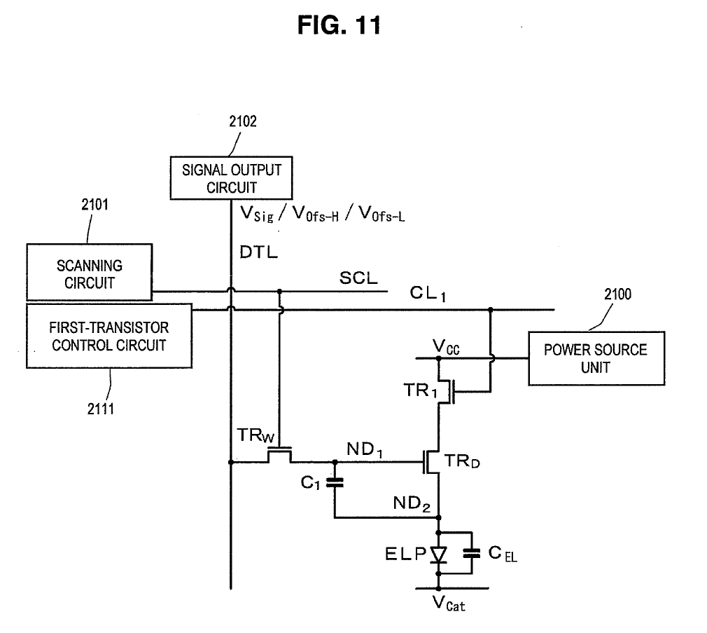

Explanation based on desirable examples was given above, by the structure of the drive circuit according to this invention is not limited to these. The constitution and structure of the respective types of constituent elements making up the display device, light emitting elements, and drive circuit and the steps in the drive method of the light emission unit explained for the respective examples are exemplifications, and can be changed suitably. For example, the 4Tr/1C drive circuit depicted in FIG. 10 or the 3Tr/1C drive circuit depicted in FIG. 11 can be employed as the drive circuit.

Additionally, in the explanation of operation of the 5Tr/1C drive circuit, write processing and mobility correction were performed discretely, but there is no limitation to this. A structure can be used in which mobility correction processing is also performed in write processing, similarly to the explanation of operation of the 2Tr/1C drive circuit. Specifically, a structure may be used that applies a video signal V_{Sig} from the data line DTL to a first node via a write transistor T_{Sig} while a light emission controlling transistor T_{EL}_{_{—}}_{C} is in an “on” state.

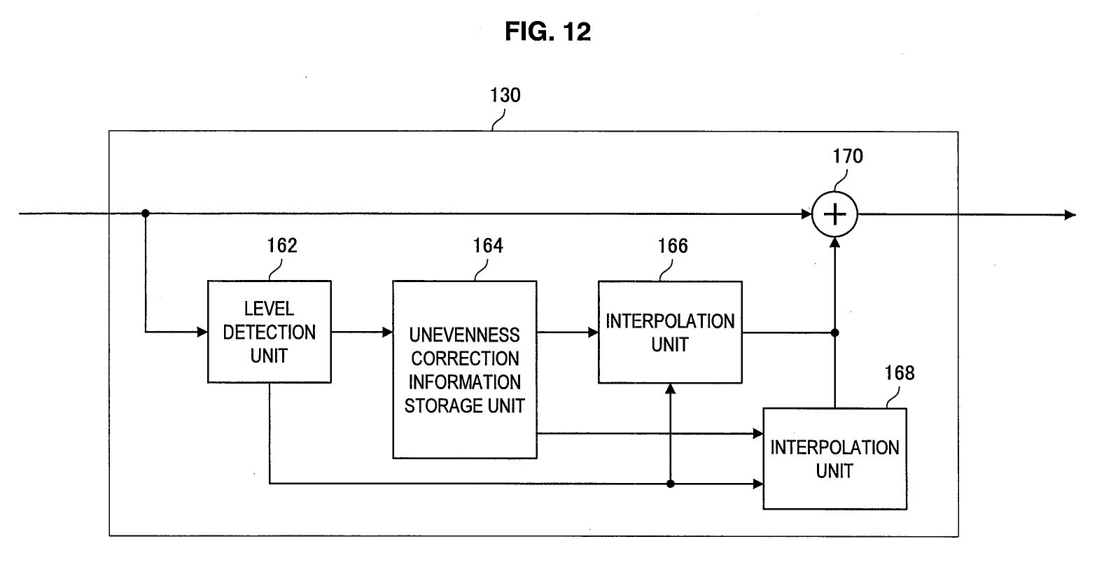

Next, the configuration of the unevenness correction unit 130 according to the embodiment of the present invention will be explained. FIG. 12 is an explanatory figure that explains the configuration of the unevenness correction unit 130 according to the embodiment of the present invention.

As shown in FIG. 12, the unevenness correction unit 130 according to the embodiment of the present invention includes a level detection unit 162, an unevenness correction information storage unit 164, interpolation units 166 and 168, and an adder 170.

The level detection unit 162 detects a voltage (a level) of a video signal. If the level detection unit 162 detects the level of the video signal, it transmits the detected level to the unevenness correction information storage unit 164.

The unevenness correction information storage unit 164 is a unit that stores information used to correct uneven light emission of an image displayed on the panel 158. As in the case of the recording unit 106, it is preferable to use, as the unevenness correction information storage unit, a memory that can store information such that the information is not deleted even when the power source of the display device 100 is off. As the memory that is adopted as the unevenness correction information storage unit 164, it is desirable to use, for example, an EEPROM that can electrically rewrite contents. Here, the information used to correct uneven light emission of the image displayed on the panel 158 will be described.

When an image display surface of the panel 158 is photographed by imaging means such as a video camera in a state where a video signal having a certain value is supplied to the panel 158, if there is no uneven light emission on the panel 158, the signal having the certain value can be obtained from the imaging means. However, if there is uneven light emission on the panel 158, a signal having a value that varies in accordance with uneven light emission is obtained from the imaging means.

Given this, in order to detect whether or not uneven light emission is occurring on the panel 158, a video signal that causes the panel 158 to emit light at a plurality of predetermined levels of luminance is supplied to the panel 158. This video signal may be generated, for example, by the pattern generation unit 118 and supplied to the panel 158, or may be generated outside of the display device 100 and supplied to the display device 100. Here, with the display device 100, the voltage applied to each pixel of the panel 158, and the luminance at each pixel of the panel 158 have a linear relationship. Accordingly, the luminance on the panel 158 varies in proportion to the signal level (the voltage) of the video signal.

If the panel 158 receives an input of the video signal that causes the panel 158 to emit light at the predetermined levels of luminance, the panel 158 emits light in accordance with the video signal. The display surface of the panel 158 that emits light is photographed by the imaging means, and the signal voltage is obtained from the image on the display surface of the panel 158 that is photographed by the imaging means. The obtained signal voltage is input to a dedicated computer (not shown in the figures) that is externally connected. Thus, correction data to correct uneven light emission at that luminance is obtained.

More specifically, when there is uneven light emission in the image displayed on the panel 158 at that luminance, the correction data to correct uneven light emission at that luminance is correction data used to correct the signal level of the video signal for a section in which uneven light emission is occurring, in order to eliminate the uneven light emission on the panel 158. The correction data is stored in the unevenness correction information storage unit 164, and the signal level of the video signal is corrected based on the stored correction data. Thus, the image can be displayed while suppressing uneven light emission that is unique to the panel 158.

As described above, a process is used in which TFTs that form pixels of the panel 158 are exposed to laser beam. Due to the exposure process that uses laser beam, uneven light emission is likely to occur as stripes in the horizontal direction and the vertical direction of the panel 158. Further, in some cases, uneven light emission occurs locally, as well as in the horizontal direction and the vertical direction of the panel 158.

For this reason, the correction data to correct uneven light emission includes correction data used to correct uneven light emission that occurs in the horizontal direction and the vertical direction of the panel 158, and correction data used to correct uneven light emission that occurs locally on the panel 158. One of the key features of the display device 100 in the present embodiment is that correction is performed by combining the correction that corrects uneven light emission that occurs in the horizontal direction and the vertical direction (hereinafter also referred to as “horizontal and vertical correction”) and the correction that corrects uneven light emission that occurs locally.

The information used to correct uneven light emission has been described above. Note that, the horizontal and vertical correction and the spot correction will be described later in detail.

The interpolation units 166 and 168 are units that generate a correction signal for correcting a video signal by interpolation. The video signal is corrected by using the correction signal generated by the interpolation unit 166 or 168. Thus, uneven light emission of the panel 158 is corrected.

Note that the difference between the interpolation unit 166 and the interpolation unit 168 is that the interpolation unit 166 generates the correction signal when uneven light emission is corrected by the horizontal and vertical correction, while the interpolation unit 168 generates the correction signal when uneven light emission is corrected by the spot correction. Whether either one of the horizontal and vertical correction or the spot correction is used to correct uneven light emission, or whether both of the horizontal and vertical correction and the spot correction are used to correct uneven light emission may be specified depending on the state of the uneven light emission occurring on the panel 158, when the correction information is recorded in the unevenness correction information storage unit 164.

The adder 170 adds the correction signals generated by the interpolation units 166 and 168, and the video signals input to the unevenness correction unit 130. By adding the correction signals generated by the interpolation units 166 and 168, and the video signals input to the unevenness correction unit 130, it is possible to correct uneven light emission of the panel 158.

The configuration of the unevenness correction unit 130 according to the embodiment of the present invention has been explained above. Next, a method for correcting uneven light emission in the display device 100 according to the embodiment of the present invention will be described.

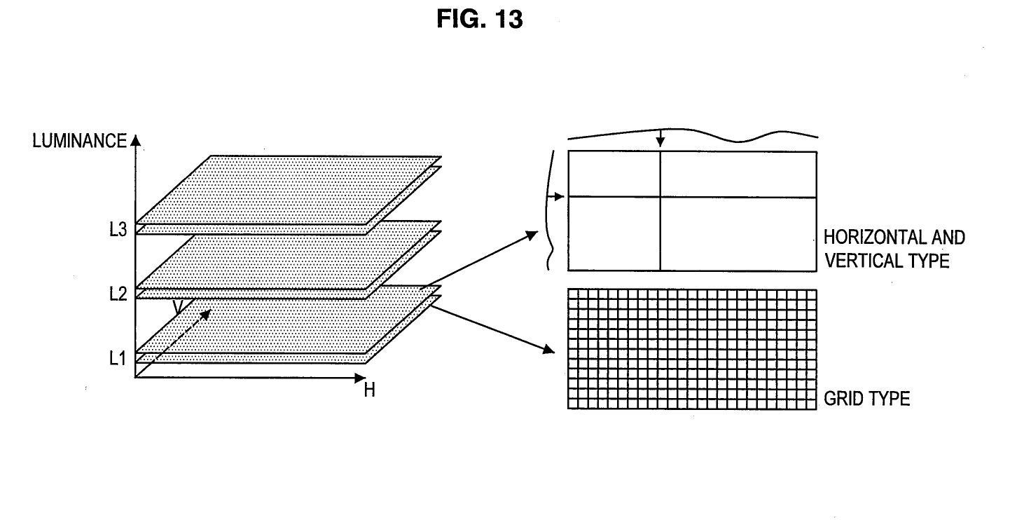

FIG. 13 is an explanatory figure that explains a concept of a method for correcting uneven light emission in the display device 100 according to the embodiment of the present invention. In the display device 100 according to the present embodiment, uneven light emission is detected by displaying an image on the panel 158 using three levels of luminance. Then, the correction data to correct uneven light emission is obtained, and the uneven light emission is corrected. The levels of luminance to be used to detect uneven light emission are denoted by L1, L2 and L3 in ascending order. As described above, the voltage applied to the panel 158 and the luminance have a linear relationship. Given this, a voltage corresponding to the luminance L1 is denoted by V1, a voltage corresponding to the luminance L2 is denoted by V2, and a voltage corresponding to the luminance L3 is denoted by V3. It is needless to mention that, in the present invention, the number of luminance levels used to obtain correction data is not limited to three. Further, in the present embodiment, the luminance L3 is set to an approximately intermediate luminance level. However, in the present invention, it is obvious that luminance setting is not limited to this example.

A video signal having a signal level corresponding to each luminance is supplied to the panel 158, and the image displayed on the panel 158 is photographed by imaging means such as a video camera as described above, thereby detecting uneven light emission of the panel 158.

Uneven light emission that occurs due to a manufacturing process of the panel 158 includes stripe-like uneven light emission that occurs in the horizontal direction and the vertical direction of the panel 158, and uneven light emission that occurs locally on the panel 158. In order to correct stripe-like uneven light emission that occurs in the horizontal direction and the vertical direction, it is appropriate to use the horizontal and vertical correction. However, uneven light emission that occurs locally is not corrected completely only by the horizontal and vertical correction. Accordingly, in order to correct uneven light emission that occurs locally on the panel 158, correction is performed by arranging detection points in a grid fashion on the display surface of the panel 158 (hereinafter also referred to as “grid type correction”).

Note that, when the grid type correction is used, if the grid scale becomes finer and finer, uneven light emission that occurs locally can be corrected completely. However, in the grid type correction, correction data is to be held for each intersection of the grid. As a result, as the grid scale becomes finer, correction data to be stored in the unevenness correction information storage unit 164 increases. Accordingly, with a limited memory capacity, constraints are generated in fineness of the grid scale when the grid type correction is performed. Further, as the grid scale becomes finer, a time period required for unevenness correction in the unevenness correction unit 130 also increases.

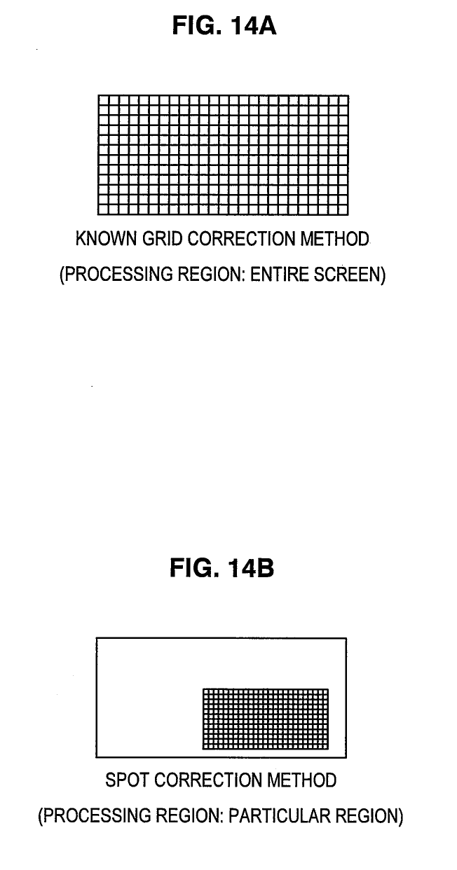

To address this, a key feature of the method for correcting uneven light emission in the display device 100 according to the embodiment of the present invention is that the processing region is limited to just a particular region in which uneven light emission is occurring as shown in FIG. 14B and the spot correction is performed, unlike the known grid type correction that takes the entire screen as the processing region as shown in FIG. 14A. If the processing region is limited to just the particular region and the spot correction is performed in this manner, the grid scale can be made finer with a limited memory capacity. Thus, uneven light emission can be further corrected.

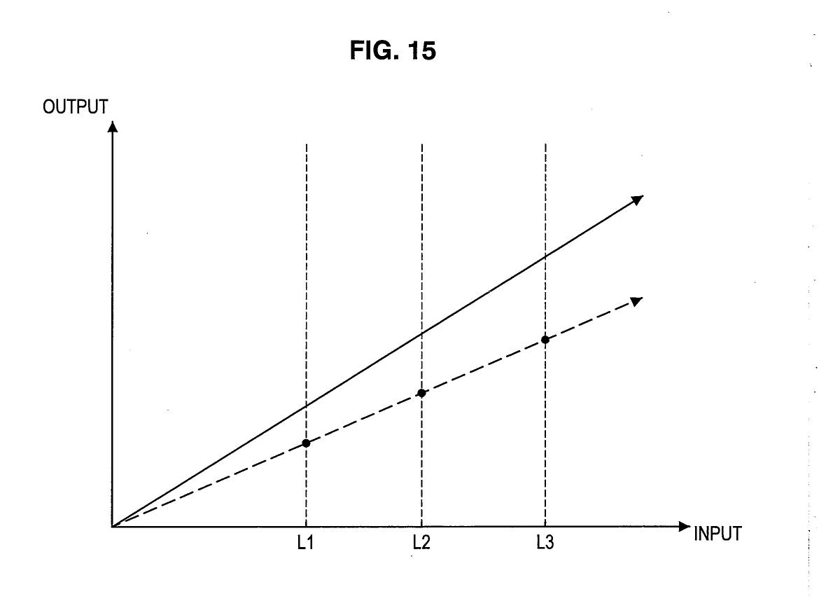

FIG. 15 is an explanatory figure that explains, in the form of a graph, about correction of uneven light emission by the method for correcting uneven light emission in the display device 100 according to the embodiment of the present invention. The horizontal axis represents the signal level (the voltage) of a video signal input to the panel 158. The vertical axis represents the luminance of an image that is output from the panel 158.

The line denoted by reference numeral 172 shows an example of an input-output characteristic that is estimated by detection of uneven light emission, in a section where uneven light emission is occurring. Further, the line denoted by reference numeral 174 shows an example of an input-output characteristic when uneven light emission is not occurring.

In this manner, when uneven light emission is occurring on the panel 158, the section where uneven light emission is occurring emits light at a lower luminance than in an original input-output characteristic. The unevenness correction unit 130 adjusts the signal level of the video signal so that the section that emits light at a lower luminance will emit light at the original luminance.

A key feature of the method for correcting uneven light emission in the display device 100 according to the embodiment of the present invention is that uneven light emission occurring on the panel 158 is corrected by appropriately combining the horizontal and vertical correction and the spot correction. Here, correction data used when a correction is made by the horizontal and vertical correction, and correction data used when a correction is made by the spot correction will be described in more detail.

When uneven light emission is corrected by the horizontal and vertical correction, correction data for the correction in the horizontal direction and correction data for the correction in the vertical direction are created. The correction data for the correction in the horizontal direction is data that is obtained by averaging, on every horizontal line, data for correcting the luminance of the panel 158 to be uniform. Similarly, the correction data for the correction in the vertical direction is data that is obtained by averaging, on every vertical line, data for correcting the luminance of the panel 158 to be uniform.

Next, the horizontal and vertical correction will be described in detail. The horizontal and vertical correction is performed in order to correct uneven light emission that occurs in the horizontal and vertical directions of the panel 158. In the horizontal and vertical correction, a plurality of pieces of correction data for the horizontal direction and the vertical direction are used for the correction. The plurality of pieces of correction data for the horizontal direction and the vertical direction may be set at equal intervals. For example, if the number of pixels of the panel 158 in the horizontal direction is 960 pixels and the number of pixels in the vertical direction is 540 pixels, the correction data may be set at 32 pixel intervals.

If a plurality of horizontal lines are assumed to be arranged on the panel 158, the correction data for the horizontal direction according to the present embodiment is correction data that is obtained by averaging, on every horizontal line, correction data for correcting the plurality of horizontal lines to have a uniform luminance in the horizontal direction. Further, if a plurality of vertical lines are assumed to be arranged on the panel 158, the correction data for the vertical direction according to the present embodiment is correction data that is obtained by averaging, on every vertical line, correction data for correcting the plurality of vertical lines to have a uniform luminance in the vertical direction.

The correction of uneven light emission in the horizontal direction is performed by repeatedly reading out from, the unevenness correction information storage unit 164, correction data for the vertical direction that corresponds to a vertical scanning position, regardless of a horizontal scanning position. As a result, it is possible to correct stripe-like uneven light emission in the horizontal direction. In a similar manner, the correction of uneven light emission in the vertical direction is performed by repeatedly reading out, from the unevenness correction information storage unit 164, correction data for the horizontal direction that corresponds to a horizontal scanning position, regardless of a vertical scanning position. As a result, it is possible to correct stripe-like uneven light emission in the vertical direction.

On the other hand, when uneven light emission is corrected by the spot correction, detection points are arranged in a grid fashion in a region in which uneven light emission is occurring. Then, data used to correct the luminance at each of the detection points to a luminance obtained when uneven light emission is not occurring is created for all the detection points (grid points). By creating the data used to correct the luminance in this manner, it is possible to suppress the uneven light emission occurring in a certain region on the screen. Thus, an image with a uniform luminance can be displayed.

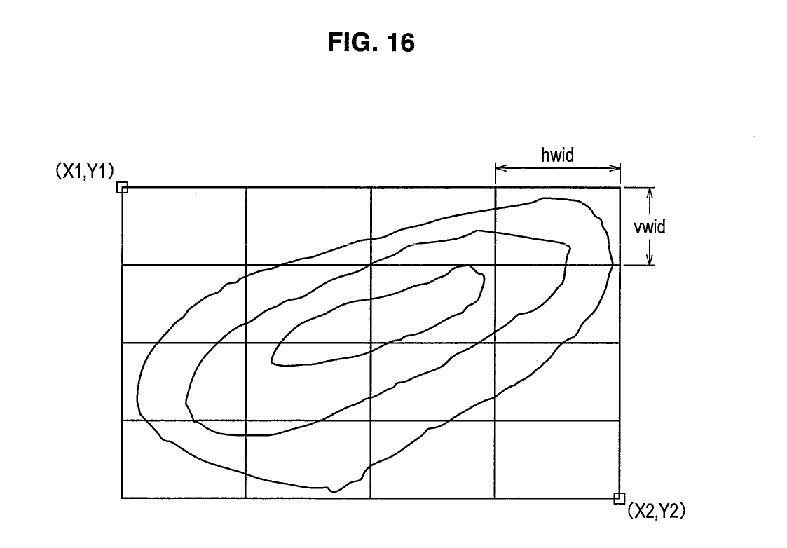

Next, a correction method that uses the spot correction will be described in detail. FIG. 16 is an explanatory figure that explains a case in which uneven light emission that is locally occurring on the panel 158 is corrected by the spot correction.

In a correction region to be corrected by the spot correction, an upper left coordinate is denoted by (X1, Y1) and a lower right coordinate is denoted by (X2, Y2). Further, a horizontal width of the grid used when the spot correction is performed is denoted by hwid, and a vertical width is denoted by vwid. Here, it is desirable that the values of hwid and vwid are the square root of 2.

The number of correction points (namely, each intersection of the grid) in the correction region shown in FIG. 16 is expressed as the following Expression 1, if the horizontal width of the correction region is denoted by hsize (=X2−X1+1) and the vertical width is denoted by vsize (=Y−Y2+1).

{(hsize/hwid)+1}×[{(vsize/vwid)/2}+1] Expression 1

In the present embodiment, in Expression 1, (hsize/hwid) and (vsize/vwid) are respectively rounded up to integers and the obtained integers are used, and {(vsize/vwid)/2} is rounded down to an integer and the obtained integer is used. In the present embodiment, the values of hwid and vwid are determined in accordance with the state of uneven light emission in the correction region, such that the value obtained from Expression 1 becomes equal to or less than a predetermined value.

If the values of hwid and vwid are determined in accordance with the state of uneven light emission in the correction region in this manner, it is possible to effectively correct the uneven light emission that occurs locally on the panel 158, using the spot correction.

The correction method that uses the spot correction has been described above. Note that the horizontal width and the vertical width of the grid in a case where the spot correction is performed may be set to be equal to an interval between the horizontal lines or between the vertical lines in a case where the horizontal and vertical correction is performed, or may be set to be less than the interval between the horizontal lines or between the vertical lines in the case where the horizontal and vertical correction is performed. It is desirable that the horizontal width and the vertical width of the grid in the case where the spot correction is performed is less than the interval between the horizontal lines or between the vertical lines in the case where the horizontal and vertical correction is performed.

The correction data used to correct uneven light emission, which is obtained in this manner, is stored in the unevenness correction information storage unit 164. Then, if a video signal is input to the unevenness correction unit 130, the signal level of the video signal is corrected by using the correction data stored in the unevenness correction information storage unit 164, and the video signal is output.

The method for correcting the signal level of a video signal by using the correction data stored in the unevenness correction information storage unit 164 will now be described in more detail.

If the level detection unit 162 detects a signal level (a voltage) of a video signal, it transmits the detected signal level to the unevenness correction information storage unit 164. The unevenness correction information storage unit 164 reads out correction data that corresponds to the signal level detected by the level detection unit 162 and that corresponds to the scanning position of the video signal.

For example, in the present embodiment, three types of luminance L1, L2 and L3 are set as the luminance to detect uneven light emission. However, when the signal level of the video signal is less than a voltage V1 that corresponds to the luminance L1, correction data at the luminance L1 is read out from the unevenness correction information storage unit 164. Then, when the horizontal and vertical correction is performed, the correction data is transmitted to the interpolation unit 166. Meanwhile, when the spot correction is performed, the correction data is transmitted to the interpolation unit 168.

Information about the signal level of the video signal detected by the level detection unit 162, and the correction data read out from the unevenness correction information storage unit 164 are input to the interpolation unit 166. Then, correction data at that signal level, which is used when the horizontal and vertical correction is performed, is generated by interpolation. In a similar manner, information about the signal level of the video signal detected by the level detection unit 162, and the correction data read out from the unevenness correction information storage unit 164 are also input to the interpolation unit 168. Then, correction data at that signal level, which is used when the spot correction is performed, is generated by interpolation.

The interpolation data generated by the interpolation units 166 and 168 are respectively input to the adder 170, and addition processing is performed on the video signal. Because the correction is made by addition in this manner, the correction can be made such that the luminance of a section in which uneven light emission is occurring becomes equal to the luminance of other sections in which uneven light emission is not occurring.

In a similar manner, when the signal level of the video signal is equal to or more than the voltage V1 that corresponds to the luminance L1, and less than the voltage V2 that corresponds to the luminance L1, correction data at the luminance L1 and correction data at the luminance L2 are read out from the unevenness correction information storage unit 164. Based on these pieces of correction data, the interpolation units 166 and 168 respectively generate correction data by interpolation.

Further, when the signal level of the video signal is equal to or more than the voltage V2 that corresponds to the luminance L2, and less than the voltage V3 that corresponds to the luminance L3, correction data at the luminance L2 and correction data at the luminance L3 are read out from the unevenness correction information storage unit 164. Based on these pieces of correction data, the interpolation units 166 and 168 respectively generate correction data by interpolation.

Further, when the signal level of the video signal is equal to or more than the voltage V3 that corresponds to the luminance L3, correction data at the luminance L3 is read out from the unevenness correction information storage unit 164. Based on this correction data, the interpolation units 166 and 168 respectively generate correction data by interpolation.

These pieces of correction data generated in this manner are also respectively input to the adder 170, and addition processing is performed on the video signal. Thus, it is possible to correct uneven light emission.

The method for correcting uneven light emission in the display device 100 according to the embodiment of the present invention has been described above.

Note that, whether either one of the horizontal and vertical correction or the spot correction is used to correct unevenness, or whether both of the horizontal and vertical correction and the spot correction are used to correct unevenness may be set in the unevenness correction unit 130 when the correction data is recorded, or may be determined by the unevenness correction unit 130 analyzing the wave width of unevenness on the screen and the color grade.

As described above, according to the embodiment of the present invention, the horizontal and vertical correction and the spot correction are combined to correct uneven light emission. Thus, images can be displayed on the panel 158 while suppressing uneven light emission caused by the manufacturing process of the panel 158. Further, the spot correction is not performed on the entire surface of the panel 158, but is performed on the region in which uneven light emission is occurring. Thus, the detection points can be finely arranged with a limited memory capacity, and uneven light emission that occurs locally on the panel 158 can be corrected, whereby images can be displayed on the panel 158.

Further, according to the embodiment of the present invention, signal processing is performed on a video signal having a linear characteristic, and correction of uneven light emission is performed. As a result, the number of detection surfaces used to detect uneven light emission can be reduced, as compared to a video signal having a gamma characteristic. For this reason, the storage capacity of the correction data used to correct uneven light emission can be reduced, leading to cost reduction of the display device 100. Additionally, it is sufficient to input the absolute value of the luminance value to the uneven correction unit 130. Therefore, the correction in the unevenness correction unit 130 can also easily be performed.

Note that the above-described unevenness correction method according to the embodiment of the present invention may be performed such that a computer program that is created to perform the unevenness correction method according to the embodiment of the present invention is recorded in advance in a recording medium (for example, the recording unit 106) provided inside the display device 100, and a computation device (for example, the control unit 104) sequentially reads out the computer program and executes it.

The preferred embodiments of the present invention have been explained above with reference to the appended drawings. However, the present invention is obviously not limited to the examples that have been given. It should be understood by those skilled in the art that various modifications, combinations, sub-combinations and alterations may occur depending on design requirements and other factors insofar as they are within the scope of the appended claims or the equivalents thereof.

For example, it is also acceptable that, when unevenness is corrected, correction is not performed on a black side (a low gradation side). This is because unevenness is corrected in a linear space and accuracy on the black side is therefore very sensitive. Further, due to limitation on the number of bits in the linear space, the black side is moved to outside of the linear space.

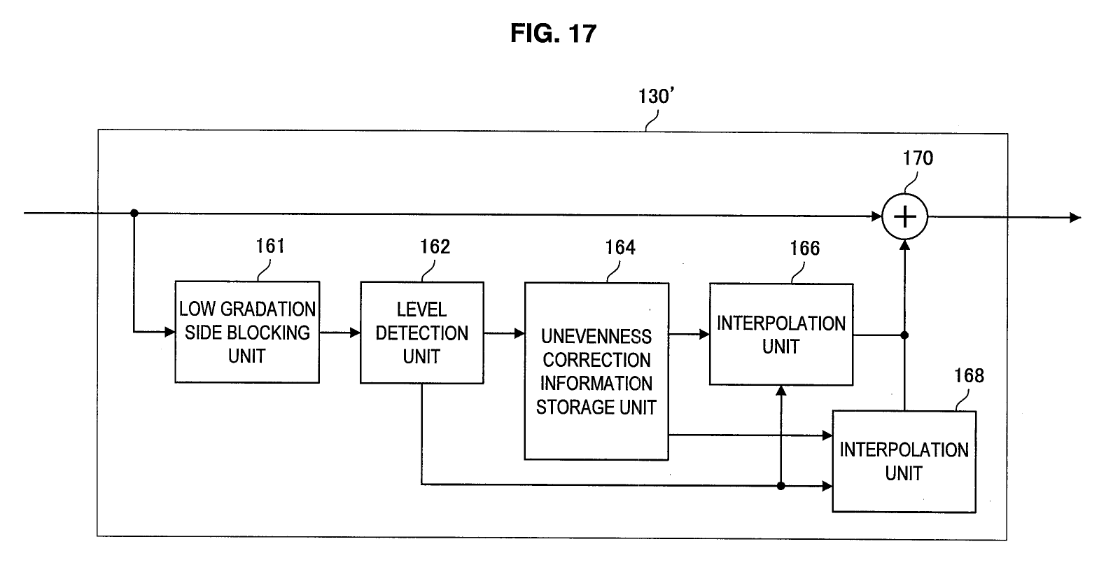

FIG. 17 is an explanatory figure that explains the configuration of an unevenness correction unit 130′, which does not perform the unevenness correction on the low gradation side. As compared to the unevenness correction unit 130 shown in FIG. 12, the unevenness correction unit 130′ shown in FIG. 17 includes a low gradation side blocking unit 161 that is provided preceding to the level detection unit 162. The low gradation side blocking unit 161 performs processing to block the low gradation side on the video signal received by the unevenness correction unit 130′, and transmits the video signal to the level detection unit 162.

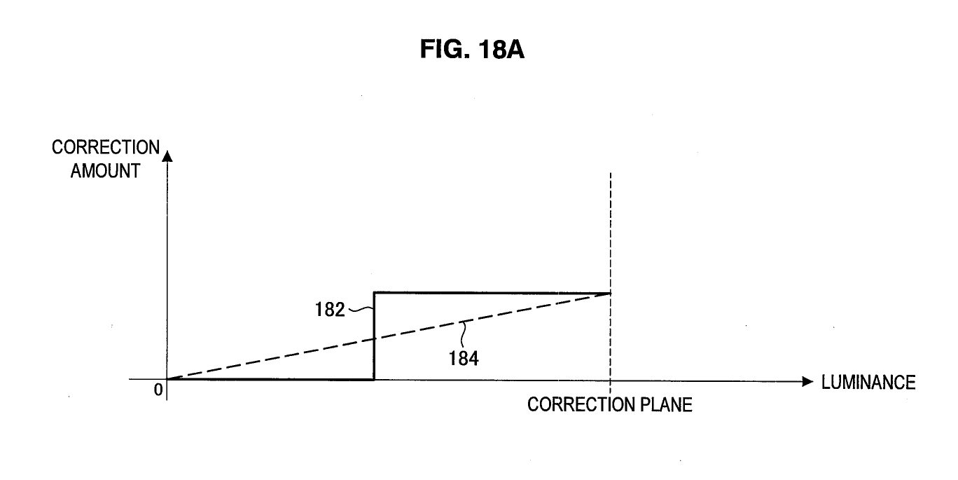

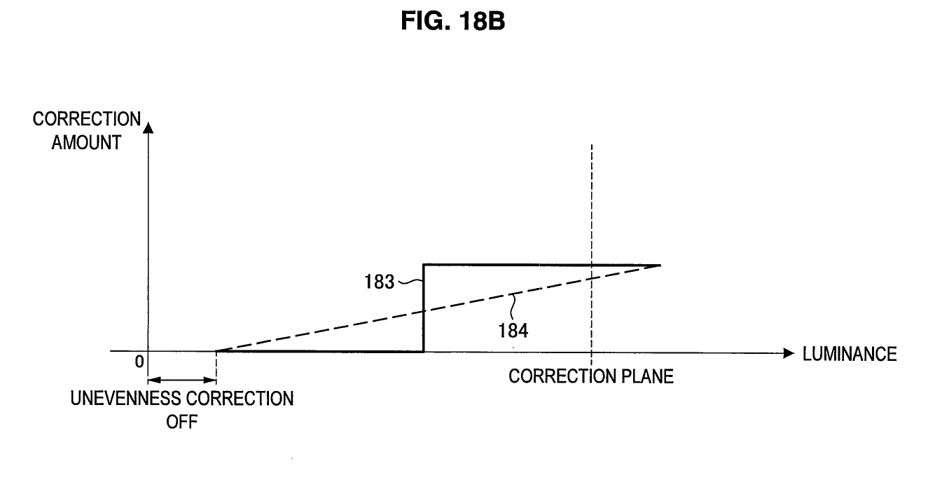

FIG. 18A is an explanatory figure that shows the manner in which unevenness correction is performed in a case where the unevenness correction is also performed on a low gradation side. The line denoted by reference numeral 182 indicates a correction amount with a quantization error, and the line denoted by reference numeral 184 indicates an ideal correction amount. FIG. 18B is an explanatory figure that shows the manner in which unevenness correction is performed in a case where the unevenness correction is not performed on a low gradation side by providing the low gradation side blocking unit 161. The line denoted by reference numeral 183 indicates a correction amount with a quantization error, and the line denoted by the reference numeral 184 indicates an ideal correction amount.

In the case shown in FIG. 18A, an error between the correction amount with a quantization error and the ideal correction amount is on the low gradation side, and unevenness is corrected in the linear space. Therefore, there is a possibility that the error between them will appear when a video image is displayed on the panel 158. On the other hand, in the case shown in FIG. 18B, an error between the correction amount with a quantization error and the ideal correction amount is shifted to a higher gradation side than in the case shown in FIG. 18A, which achieves the effect that the error between them will not appear even when a video image is displayed on the panel 158.

1. A display device that includes a display unit in which a pixel, a scanning line and a data line are arranged in the form of a matrix, the pixel having a light emitting element that emits light in accordance with an amount of an electric current and a pixel circuit that controls, in accordance with a video signal, an electric current applied to the light emitting element, the scanning line supplying to the pixel, in a predetermined scan cycle, a selection signal that selects the pixel that will emit light, and the data line supplying the video signal to the pixel, the display device being characterized by comprising:
an unevenness correction information storage unit that stores unevenness correction information used to correct uneven light emission of the display unit; and
an unevenness correction unit that corrects uneven light emission of the display unit by reading out the unevenness correction information from the unevenness correction information storage unit and by performing signal processing on the video signal having a linear characteristic,
wherein
the unevenness correction unit corrects the uneven light emission by using a first correction that is applied to a section in which uneven light emission is occurring in a horizontal direction or a vertical direction of the display unit, and/or a second correction that is applied to a section of the display unit in which uneven light emission is occurring.

2. A method for correcting uneven light emission of a display device that includes a display unit in which a pixel, a scanning line and a data line are arranged in the form of a matrix, the pixel having a light emitting element that emits light in accordance with an amount of an electric current and a pixel circuit that controls, in accordance with a video signal, an electric current applied to the light emitting element, the scanning line supplying to the pixel, in a predetermined scan cycle, a selection signal that selects the pixel that will emit light, and the data line supplying the video signal to the pixel, the method being characterized by comprising the steps of:
storing unevenness correction information used to correct uneven light emission of the display unit; and
correcting unevenness by reading out the unevenness correction information stored in the unevenness correction information storing step and by performing signal processing on the video signal having a linear characteristic,
wherein
the unevenness correction step corrects the uneven light emission by using a first correction that is applied to a section in which uneven light emission is occurring in a horizontal direction or a vertical direction of the display unit, and/or a second correction that is applied to a section of the display unit in which uneven light emission is occurring.

3. A computer program that causes a computer to execute control of a display device that includes a display unit in which a pixel, a scanning line and a data line are arranged in the form of a matrix, the pixel having a light emitting element that emits light in accordance with an amount of an electric current and a pixel circuit that controls, in accordance with a video signal, an electric current applied to the light emitting element, the scanning line supplying to the pixel, in a predetermined scan cycle, a selection signal that selects the pixel that will emit light, and the data line supplying the video signal to the pixel, the computer program being characterized by comprising the step of:
correcting unevenness by performing signal processing on the video signal having a linear characteristic, based on unevenness correction information that is used to correct uneven light emission of the display device and that is stored in advance,
wherein
the unevenness correction step corrects the uneven light emission by using a first correction that is applied to a section in which uneven light emission is occurring in a horizontal direction or a vertical direction of the display unit, and/or a second correction that is applied to a section of the display unit in which uneven light emission is occurring.
